(19) United States
(12) Patent Application Publication
(10) Pub. No.: US 2023/0325964 A1
(43) Pub. Date: Oct. 12, 2023

(54) SYSTEMS AND METHODS FOR GENERATING AND RUNNING COMPUTER VISION PIPELINES FOR PROCESSING OF IMAGES AND/OR VIDEO

(71) Applicant: Plainsight Corp., San Francisco, CA (US)

(72) Inventors: Carlos Anchia, Plano, TX (US); Logan Spears, Kingston, WA (US)

(73) Assignee: Plainsight Corp., San Francisco, CA (US)

(21) Appl. No.: 18/186,128

(22) Filed: Mar. 17, 2023

Related U.S. Application Data
(60) Provisional application No. 63/269,540, filed on Mar. 17, 2022.

(51) Int. Cl. G06T 3/40; G06V 10/94; G06T 1/20; G06F 3/0486; G06V 10/26; G06V 10/764

(52) U.S. Cl. CPC G06T 1/20; G06F 3/0486; G06T 3/40; G06V 10/26; G06V 10/764; G06V 10/945; G06V 10/955; G06T 2200/24; G06V 20/70; G06V 2201/09

(57) ABSTRACT

Generating and running computer vision pipelines for processing images and/or video. A user may select blocks for the computer vision pipeline, including image transformation blocks that transform images and/or video, and prediction blocks that detect objects or classes of objects in images and/or video. The user may specify an input source for the images and/or video and an output destination for the computer vision pipeline. Upon activation, the computer vision pipeline receives input images and/or video. The input images and/or video are transformed using the image transformation block to produce transformed images and/or video. Objects or classes of objects in the transformed images and/or video are detected using the prediction block to produce detected objects or classes of objects. The detected objects or classes of objects are transmitted to the output destination.

### CROSS-REFERENCE TO RELATED APPLICATION

This application claims priority to U.S. Provisional Patent Application No. 63/269,540, filed on Mar. 17, 2022 and entitled “SYSTEMS AND METHODS FOR IMPROVED IMAGE PIPELINE FOR MACHINE LEARNING APPLICATIONS,” which is incorporated in its entirety herein by reference.

### FIELD OF THE INVENTION(S)

Embodiments of the present invention(s) are generally related to generating and running computer vision pipelines for processing images and/or video, and in particular to generating computer vision pipelines for processing images and/or video utilizing image transformation blocks that transform images and/or video and prediction blocks that detect objects or classes of objects in images and/or video.

### BACKGROUND

Computer vision generally refers to utilizing computing devices to analyze images and/or video so as to obtain high-level understandings of the images and/or video. Applications of computer vision include detecting product defects on assembly lines, monitoring personal protective equipment (PPE) compliance at construction sites, and monitoring and detecting gas and fluid leaks.

Computer vision models may be used to process the images and/or video. Software engineers and data scientists may use software, such as Jupyter notebooks from Project Jupyter, to implement computer vision models.

### SUMMARY

In some aspects, the techniques described herein relate to a non-transitory computer-readable medium including executable instructions, the executable instructions being executable by one or more processors to perform a method, the method including: receiving a request to create a computer vision pipeline for processing images and/or video; receiving an input source for images and/or video for the computer vision pipeline; displaying multiple blocks for selection, the multiple blocks including multiple image transformation blocks, an image transformation block transforming images and/or video to produce transformed images and/or video, and multiple prediction blocks, a prediction block detecting objects or classes of objects in images and/or video to produce detected objects or classes of objects; receiving a selection of an image transformation block and configuration information for the image transformation block; adding the image transformation block to the computer vision pipeline; receiving a selection of a prediction block and configuration information for the prediction block; adding the prediction block to the computer vision pipeline; receiving an output destination for the computer vision pipeline; receiving a request to activate the computer vision pipeline; activating the computer vision pipeline; receiving input images and/or video from the input source; transforming, using the image transformation block, the input images and/or video to produce transformed images and/or video; detecting, using the prediction block, objects or classes of objects in the transformed images and/or video to produce detected objects or classes of objects; and transmitting the detected objects or classes of objects to the output destination.

In some aspects, the techniques described herein relate to a non-transitory computer-readable medium, the method further including displaying a user interface element into which a block may be dragged and dropped to select the block, and wherein receiving the selection of the image transformation block and configuration information for the image transformation block includes receiving a dragging and dropping of the image transformation block into the user interface element, and receiving the selection of the prediction block and configuration information for the prediction block includes receiving a dragging and dropping of the prediction block into the user interface element.

In some aspects, the techniques described herein relate to a non-transitory computer-readable medium, the method further including: receiving a computer vision pipeline type, the computer vision pipeline type being one of a batch type or a streaming type; if the computer vision pipeline type is the batch type, receiving a processing schedule, wherein receiving input images and/or video from the input source includes receiving input images and/or video from the input source according to the processing schedule; and if the computer vision pipeline type is a streaming type, wherein receiving input images and/or video from the input source includes continually receiving input images and/or video from the input source.

In some aspects, the techniques described herein relate to a non-transitory computer-readable medium wherein the multiple image transformation blocks include an image crop block that crops images and/or video and an image resize block that resizes images and/or video.

In some aspects, the techniques described herein relate to a non-transitory computer-readable medium wherein the multiple prediction blocks include a tiled model block that splits images and/or video into multiple images for detection of objects or classes of objects, detects objects or classes of objects in the multiple images, recombines the multiple images to produce transformed images and/or video, and produces the transformed images and/or videos and detections of objects or classes of objects.

In some aspects, the techniques described herein relate to a non-transitory computer-readable medium wherein the multiple prediction blocks include a label detection block that detects objects in images and/or video and produces one or more label descriptions for the detected objects, a landmark detection block that detects landmarks in images and/or video and produces a detected landmark description, and a logo detection block that detects logos in images and/or video and returns a detected logo description.

In some aspects, the techniques described herein relate to a non-transitory computer-readable medium, the method further including displaying a summary of the computer vision pipeline, the summary including the input source, the image transformation block, the prediction block, an order of the image transformation block and the prediction block in the computer vision pipeline, and the output destination.

In some aspects, the techniques described herein relate to a system including at least one processor and memory containing instructions, the instructions being executable by the at least one processor to: receive a request to create a computer vision pipeline for processing images and/or video; receive an input source for images and/or video for the computer vision pipeline; display multiple blocks for selection, the multiple blocks including multiple image transformation blocks, an image transformation block transforming images and/or video to produce transformed images and/or video, and multiple prediction blocks, a prediction block detecting objects or classes of objects in images and/or video to produce detected objects or classes of objects; receive a selection of an image transformation block and configuration information for the image transformation block; add the image transformation block to the computer vision pipeline; receive a selection of a prediction block and configuration information for the prediction block; add the prediction block to the computer vision pipeline; receive an output destination for the computer vision pipeline; receive a request to activate the computer vision pipeline; activate the computer vision pipeline; receive input images and/or video from the input source; transform, using the image transformation block, the input images and/or video to produce transformed images and/or video; detect, using the prediction block, objects or classes of objects in the transformed images and/or video to produce detected objects or classes of objects; and transmit the detected objects or classes of objects to the output destination.

In some aspects, the techniques described herein relate to a system, the instructions being further executable by the at least one processor to display a user interface element into which a block may be dragged and dropped to select the block, and wherein the instructions being executable by the at least one processor to receive the selection of the image transformation block and configuration information for the image transformation block include instructions being executable by the at least one processor to receive a dragging and dropping of the image transformation block into the user interface element, and wherein the instructions being executable by the at least one processor to receive the selection of the prediction block and configuration information for the prediction block include instructions being executable by the at least one processor to receive a dragging and dropping of the prediction block into the user interface element.

In some aspects, the techniques described herein relate to a system, the instructions being further executable by the at least one processor to: receive a computer vision pipeline type, the computer vision pipeline type being one of a batch type or a streaming type; if the computer vision pipeline type is the batch type, receive a processing schedule, wherein the instructions being executable by the at least one processor to receive input images and/or video from the input source includes instructions being executable by the at least one processor to receive input images and/or video from the input source according to the processing schedule; and if the computer vision pipeline type is a streaming type, wherein the instructions being executable by the at least one processor to receive input images and/or video from the input source includes instructions being executable by the at least one processor to continually receive input images and/or video from the input source.

In some aspects, the techniques described herein relate to a system wherein the multiple image transformation blocks include an image crop block that crops images and/or video and an image resize block that resizes images and/or video.

In some aspects, the techniques described herein relate to a system wherein the multiple prediction blocks include a tiled model block that splits images and/or video into multiple images for detection of objects or classes of objects, detects objects or classes of objects in the multiple images, recombines the multiple images to produce transformed images and/or video, and produces the transformed images and/or videos and detections of objects or classes of objects.

In some aspects, the techniques described herein relate to a system wherein the multiple prediction blocks include a tiled model block that splits images and/or video into multiple images for detection of objects or classes of objects, detects objects or classes of objects in the multiple images, recombines the multiple images to produce transformed images and/or video, and produces the transformed images and/or videos and detections of objects or classes of objects.

In some aspects, the techniques described herein relate to a system, the instructions being further executable by the at least one processor to display a summary of the computer vision pipeline, the summary including the input source, the image transformation block, the prediction block, an order of the image transformation block and the prediction block in the computer vision pipeline, and the output destination.

In some aspects, the techniques described herein relate to a method including: receiving a request to create a computer vision pipeline for processing images and/or video; receiving an input source for images and/or video for the computer vision pipeline; displaying multiple blocks for selection, the multiple blocks including multiple image transformation blocks, an image transformation block transforming images and/or video to produce transformed images and/or video, and multiple prediction blocks, a prediction block detecting objects or classes of objects in images and/or video to produce detected objects or classes of objects; receiving a selection of an image transformation block and configuration information for the image transformation block; adding the image transformation block to the computer vision pipeline; receiving a selection of a prediction block and configuration information for the prediction block; adding the prediction block to the computer vision pipeline; receiving an output destination for the computer vision pipeline; receiving a request to activate the computer vision pipeline; activating the computer vision pipeline; receiving input images and/or video from the input source; transforming, using the image transformation block, the input images and/or video to produce transformed images and/or video; detecting, using the prediction block, objects or classes of objects in the transformed images and/or video to produce detected objects or classes of objects; and transmitting the detected objects or classes of objects to the output destination.

In some aspects, the techniques described herein relate to a method, further including displaying a user interface element into which a block may be dragged and dropped to select the block, and wherein receiving the selection of the image transformation block and configuration information for the image transformation block includes receiving a dragging and dropping of the image transformation block into the user interface element, and receiving the selection of the prediction block and configuration information for the prediction block includes receiving a dragging and dropping of the prediction block into the user interface element.

In some aspects, the techniques described herein relate to a method, further including: receiving a computer vision pipeline type, the computer vision pipeline type being one of a batch type or a streaming type; if the computer vision pipeline type is the batch type, receiving a processing schedule, wherein receiving input images and/or video from the input source includes receiving input images and/or video from the input source according to the processing schedule; and if the computer vision pipeline type is a streaming type, wherein receiving input images and/or video from the input source includes continually receiving input images and/or video from the input source.

In some aspects, the techniques described herein relate to a method wherein the multiple image transformation blocks include an image crop block that crops images and/or video and an image resize block that resizes images and/or video.

In some aspects, the techniques described herein relate to a method wherein the multiple prediction blocks include a tiled model block that splits images and/or video into multiple images for detection of objects or classes of objects, detects objects or classes of objects in the multiple images, recombines the multiple images to produce transformed images and/or video, and produces the transformed images and/or videos and detections of objects or classes of objects.

In some aspects, the techniques described herein relate to a method wherein the multiple prediction blocks include a label detection block that detects objects in images and/or video and produces one or more label descriptions for the detected objects, a landmark detection block that detects landmarks in images and/or video and produces a detected landmark description, and a logo detection block that detects logos in images and/or video and returns a detected logo description.

### BRIEF DESCRIPTION OF THE DRAWINGS

FIG. 1 depicts an example environment in which computer vision pipelines may be created and run in some embodiments.

FIG. 2 depicts components of a computer vision pipeline system in some embodiments.

FIG. 3 depicts a method for creating and running a computer vision pipeline in some embodiments.

FIG. 4 depicts an example interface for receiving a request to create a new computer vision pipeline in some embodiments.

FIG. 5A depicts an example interface for receiving a computer vision pipeline name, a computer vision pipeline type, and a computer vision pipeline input type in some embodiments.

FIG. 5B depicts another example interface for receiving a computer vision pipeline name, a computer vision pipeline type, and a computer vision pipeline input type in some embodiments.

FIG. 6A depicts an example interface for receiving an input source for images and/or video for a computer vision pipeline in some embodiments.

FIG. 6B depicts another example interface for receiving an input source for images and/or video for a computer vision pipeline in some embodiments.

FIG. 6C depicts an example interface for receiving a computer vision pipeline processing schedule in some embodiments.

FIG. 7 depicts an example interface for receiving selections of blocks for a computer vision pipeline in some embodiments.

FIG. 8A depicts an example interface for receiving configuration information for an image crop block that crops images and/or video in some embodiments.

FIG. 8B depicts an example interface for receiving configuration information for an image resize block that resizes images and/or video in some embodiments.

FIG. 9A depicts an example interface for receiving configuration information for a single model block in some embodiments.

FIG. 9B depicts an example interface for receiving configuration information for a tiled model block in some embodiments.

FIG. 9C depicts another example interface for receiving configuration information for a tiled model block in some embodiments.

FIG. 9D depicts an example interface for receiving configuration information for a general object detection block in some embodiments.

FIG. 9E depicts an example interface for receiving configuration information for an object tracking block in some embodiments.

FIG. 9F depicts an example interface for receiving configuration information for a label detection block in some embodiments.

FIG. 9G depicts an example interface for receiving configuration information for a landmark detection block in some embodiments.

FIG. 9H depicts an example interface for receiving configuration information for a logo detection block in some embodiments.

FIG. 9I depicts an example interface for receiving configuration information for an image properties block in some embodiments.

FIG. 10 depicts the example interface of FIG. 7 with multiple blocks added to a computer vision pipeline in some embodiments.

FIG. 11 depicts an example interface for receiving an output destination for a computer vision pipeline in some embodiments.

FIG. 12 depicts an example interface for displaying a summary for a computer vision pipeline and for receiving a request to activate a computer vision pipeline in some embodiments.

FIG. 13 depicts an example interface for displaying a summary of a computer vision pipeline and for receiving a request to modify a computer vision pipeline in some embodiments.

FIG. 14 depicts an example interface for displaying a summary of multiple computer vision pipelines in some embodiments.

FIG. 15 depicts an example use of a computer vision pipeline in some embodiments.

FIGS. 16A and 16B depict example outputs of prediction blocks in some embodiments.

FIG. 17 depicts a block diagram of an example digital device in some embodiments.

Throughout the drawings, like reference numerals will be understood to refer to like parts, components, and structures.

### DETAILED DESCRIPTION

In order to implement computer vision models using software such as Jupyter notebooks, software engineers and data scientists typically must write software in order to load training data, train computer vision models using the training data, perform inference using the trained computer vision models, and save the results of the inference. Such an approach has several disadvantages. First, it may require a certain level of software development experience. Second, it may require extensive configurations to the computer vision models in order to achieve the desired objectives. Third, such an approach is not very scalable to multiple organizations or even to multiple users within an organization. Further, while data engineers are highly specialized (as they need to be given the nature of the manual coding and construction of the analysis system), they rarely have the subject matter expertise required to ensure that incorrect assumptions are avoided, that specific features are identified, and that the output is well crafted to fit the business need.

In some embodiments, the computer vision pipeline systems described herein allow users to implement computer vision solutions without having to write software (e.g., as a “no code” or “low code” system). The computer vision pipeline systems allow users with no or little software development experience to create, run, and modify computer vision pipelines for processing images and/or video. In various embodiments, the computer vision pipeline systems provide interfaces that allow users to select blocks quickly and easily for computer vision pipelines, configure the blocks, and activate the computer vision pipelines.

In some embodiments, a computer vision pipeline system may include a graphical user interface with interactive visual elements. An interactive visual element may represent a function or combination of functions that have been previously coded. In some embodiments, the interactive visual element may be represented as a “block” or any other representation. Although the term “block” is used herein, it will be appreciated that the visual element representing one or more functions may be any shape (or combination of different shapes), media, animation, and/or the like.

In some embodiments, the blocks for computer vision pipelines include image transformation blocks that transform images and/or video. Image transformation blocks may be used at the beginning of a computer vision pipeline to transform the input images and/or video. The blocks also include prediction blocks that detect objects and/or classes of objects in images and/or video. Prediction blocks add inference metadata to images and/or video in computer vision pipelines.

In addition to the above advantages, the computer vision pipeline systems allow users to quickly and easily specify input sources for images and/or video and output destinations for inference data and/or processed images and/or video. Furthermore, the computer vision pipeline systems allow users to specify whether the computer vision pipeline is to process images and/or video continually or on a scheduled basis, and if the latter, a processing schedule.

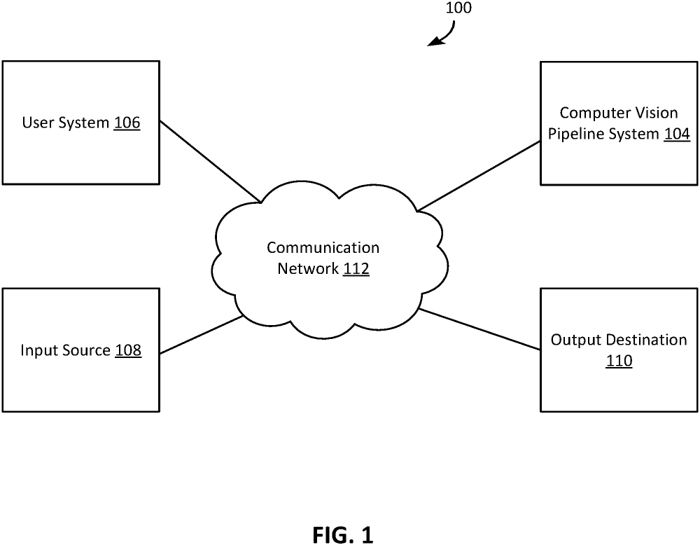

In part due to inherent ease of use, distributed processing, ability to customize, and/or other aspects, the computer vision pipeline systems are scalable. Further, a centralized system (as shown in FIG. 1) may allow multiple users within an organization and any number of different organizations to utilize the computer vision pipeline system to create platforms and/or applications for computer vision tasks.

Moreover, it will be appreciated that the “low code” or “no code” systems discussed herein allow different users of different experience (i.e., not just those who are dedicated data engineers or those with extensive coding experience) to create computer vision pipelines through the computer vision interface. As a result, users with subject matter expertise may be enabled to leverage their understanding of the business, problem, and solution to create computer visions applications, platforms, and/or processes that are crafted to the business’ particular needs.

Further, by utilizing previously coded “blocks” (i.e., functionality), different businesses and users may leverage the systems and flexibility without individually coding different processes. As a result, considerable time and computer resources are saved by avoiding debugging of new code, testing, updating, justification, and documentation which are typically required for all new code for important systems. Other advantages of the computer vision pipeline systems will be apparent.

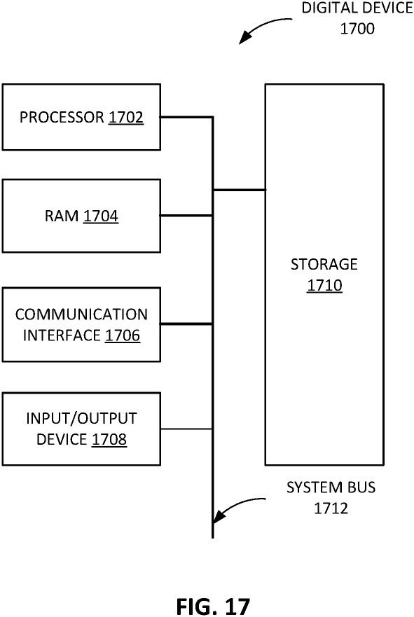

FIG. 1 depicts an example environment 100 in which computer vision pipelines may be created and run in some embodiments. The example environment 100 includes a computer vision pipeline system 104, a user system 106, an input source system 108, an output destination system 110, and a communication network 112. Each of the computer vision pipeline system 104, the user system 106, the input source system 108, and the output destination system 110 may be or include any number of digital devices. A digital device is any device with at least one processor and memory. Digital devices are further discussed herein, for example, with reference to FIG. 17.

The computer vision pipeline system 104 may provide interfaces for creating, activating, running, and managing computer vision pipelines. The computer vision pipeline system 104 may provide such interfaces to the user system 106 so as to allow a user of the user system 106 to, among other things, request that the computer vision pipeline system 104 create a computer vision pipeline, select blocks for the computer vision pipeline, and request that the computer vision pipeline system 104 activate and run the computer vision pipeline. The computer vision pipeline system 104 receives input images and/or video from the input source system 108 and processes the input images and/or video. The computer vision pipeline system 104 may process the input images and/or video by transforming the input images and/or video, and/or by detecting objects and/or classes of objects in the input images and/or video. The computer vision pipeline system 104 transmits detected objects and/or classes of objects, and optionally, the transformed images and/or video to the output destination system 110.

The user system 106 may display interfaces to a user that the user may utilize to request creation of a computer vision pipeline, select blocks for the computer vision pipeline, and request activation and running of the computer vision pipeline. The user system 106 may also display interfaces that the user may utilize to specify input sources and output destinations for the computer vision pipeline, configure blocks for the computer vision pipeline, and manage the computer vision pipeline.

The input source system 108 may be or include any system that may provide images and/or video. The input source system 108 may be or include cloud storage providers such as Google Cloud Storage and Amazon S3, messaging services such as Google Pub/Sub, and local data storage. The input source system 108 may be or include cameras or sensors (for example, security cameras) that continually stream images and/or video. The input source system 108 may be or include systems that provide satellite and/or airborne images and/or video. The input source system 108 transmits images and/or video to the computer vision pipeline system 104.

The output destination system 110 may be or include cloud storage providers such as Google Cloud Storage and Amazon S3, messaging services such as Google Pub/Sub, and local data storage. The output destination system 110 may receive detected objects and/or classes of objects, and optionally, processed images and/or video, from the computer vision pipeline system 104.

In some embodiments, the communication network 112 may represent one or more computer networks (for example, LAN, WAN, and/or the like). The communication network 112 may provide communication between any of the computer vision pipeline system 104, the user system 106, the input source system 108, and the output destination system 110. In some implementations, the communication network 112 comprises computer devices, routers, cables, uses, and/or other network topologies. In some embodiments, the communication network 112 may be wired and/or wireless. In various embodiments, the communication network 112 may comprise the Internet, one or more networks that may be public, private, IP-based, non-IP based, and so forth.

FIG. 1 depicts the environment 100 as including only one of each of the computer vision pipeline system 104, the user system 106, the input source system 108, the output destination system 110, and the communication network 112. However, the environment 100 may include more than a single one of any of the computer vision pipeline system 104, the user system 106, the input source system 108, the output destination system 110, and the communication network 112.

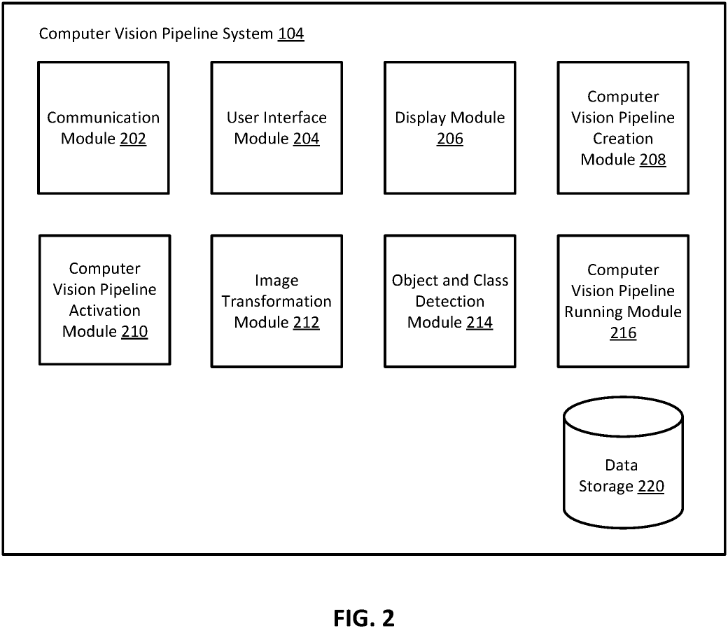

FIG. 2 depicts components of the computer vision pipeline system 104 in some embodiments. The computer vision pipeline system 104 includes a communication module 202, a user interface module 204, a display module 206, a computer vision pipeline creation module 208, a computer vision pipeline activation module 210, an image transformation module 212, an object and class detection module 214, a computer vision pipeline running module 216, and a data storage 220.

The communication module 202 may send and/or receive requests and/or data between the computer vision pipeline system 104 and any of the user system 106, the input source system 108, and the output destination system 110. The communication module 202 may receive requests and/or data from the user system 106, the input source system 108, and the output destination system 110. The communication module 202 may also send requests and/or data to the user system 106, the input source system 108, and the output destination system 110.

The user interface module 204 may receive requests to create, modify, and run computer vision pipelines. The display module 206 may display and/or provide for display interfaces for users to interact with to create, activate, run, and modify computer vision pipelines. The computer vision pipeline creation module 208 may add blocks that users have selected to computer vision pipelines.

The computer vision pipeline activation module 210 may activate computer vision pipelines. The image transformation module 212 may cause an image transformation block, if a computer vision pipeline contains an image transformation block, to transform images and/or video and to produce transformed images. The object and class detection module 214 may cause a prediction block, if a computer vision pipeline contains a prediction block, to detect objects or classes of objects in images and/or video and to produce detected objects or classes of objects.

The computer vision pipeline running module 216 may run a computer vision pipeline. The computer vision pipeline running module 216 may translate a computer vision pipeline into a directed acyclic graph (DAG), such as an Apache Beam-based DAG, to run the computer vision pipeline.

The data storage 220 may include data stored, accessed, and/or modified by any of the modules of the computer vision pipeline system 104, such as the computer vision pipelines created by users, images and/or video, and inference data. The data storage 220 may include any number of data storage structures such as tables, databases, lists, and/or the like.

A module may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, and/or any combination. Software may be executed by one or more processors. Although a limited number of modules are depicted in FIG. 2, there may be any number of modules. Further, individual modules may perform any number of functions, including functions of multiple modules as shown herein.

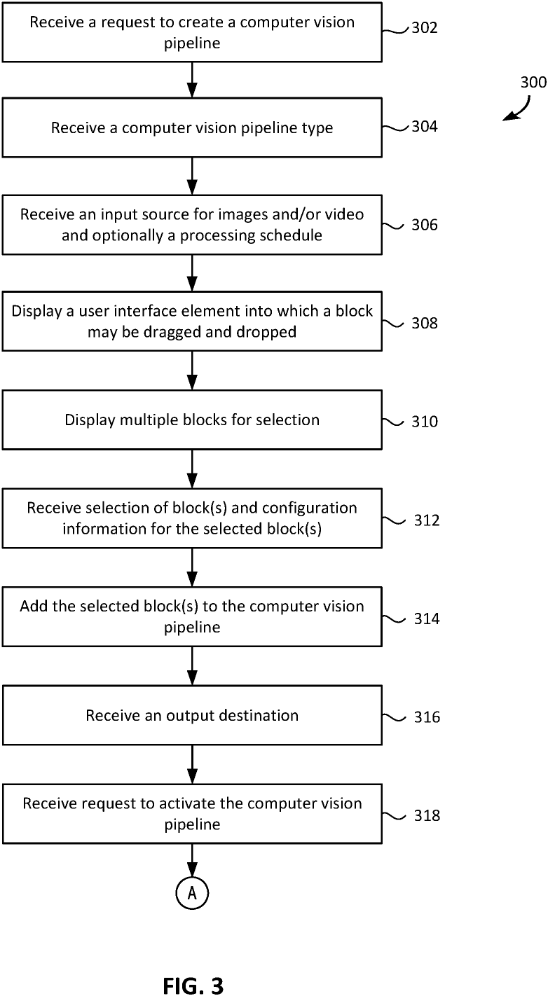

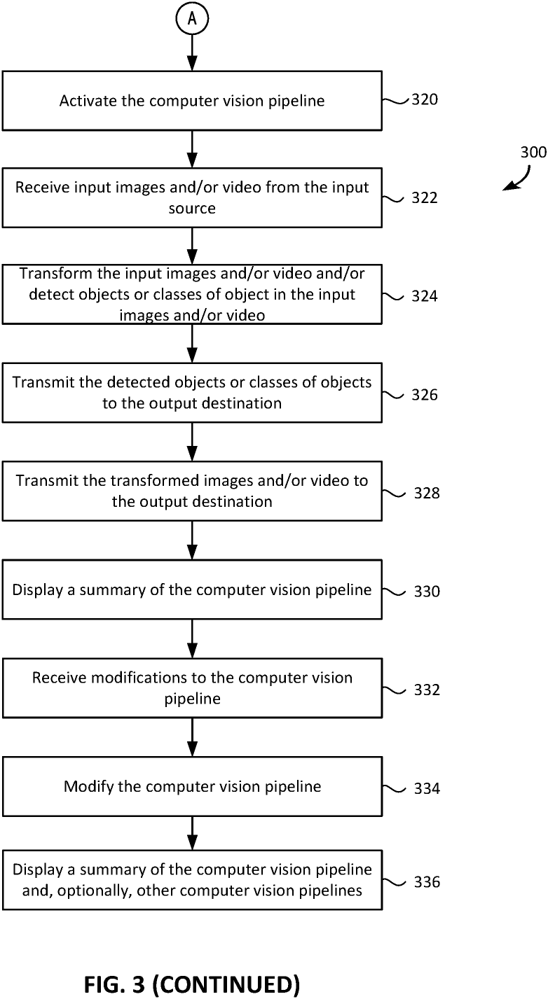

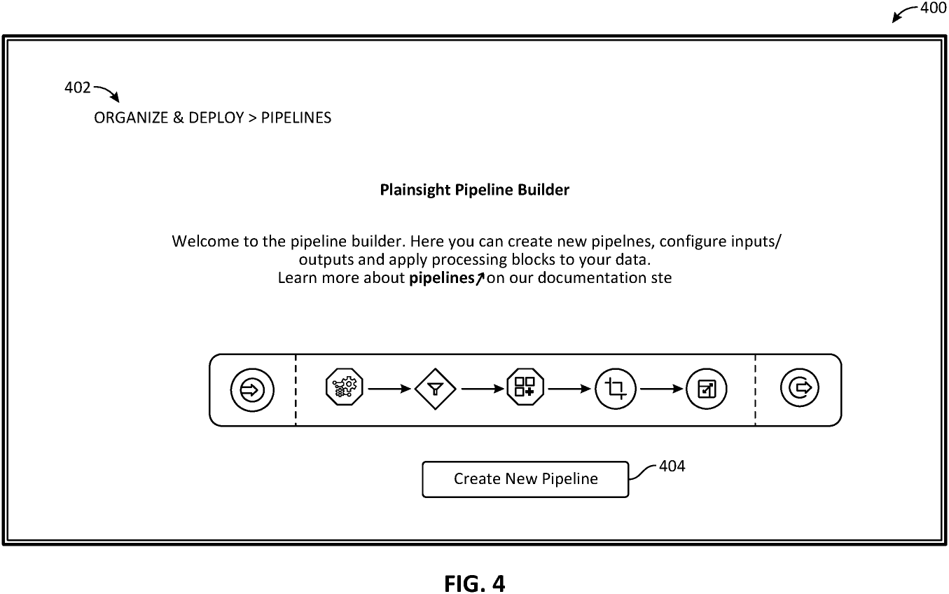

FIG. 3 depicts a method 300 for creating and running a computer vision pipeline in some embodiments. The computer vision pipeline system 104 may perform the method 300. The method 300 begins at a step 302, where the user interface module 204 receives a request to create a computer vision pipeline for processing images and/or video. FIG. 4 depicts an example interface 400 for receiving a request to create a new computer vision pipeline in some embodiments. The display module 206 may display the interface 400, and the other interfaces described herein, to a user of the user system 106. The interface 400 includes a navigation element 402 that indicates to the user that the user is creating and/or managing computer vision pipelines. The interface 400 also includes a button 404 labeled “Create New Pipeline.” The user can select the button 404 to request that the computer vision pipeline system 104 create a computer vision pipeline. The user system 106 transmits the request to the computer vision pipeline system 104.

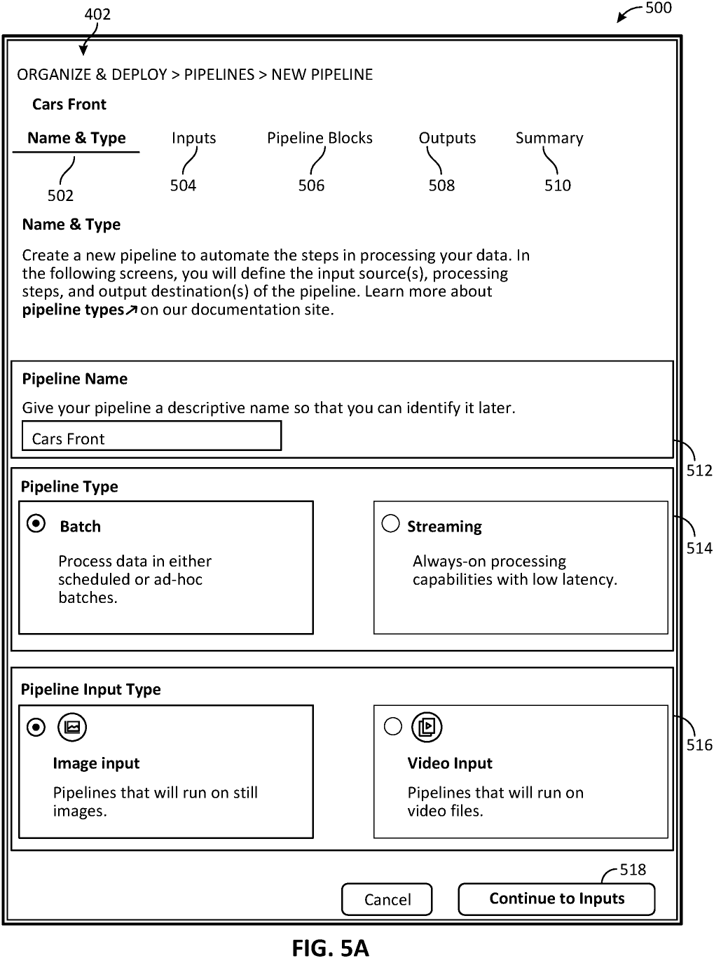

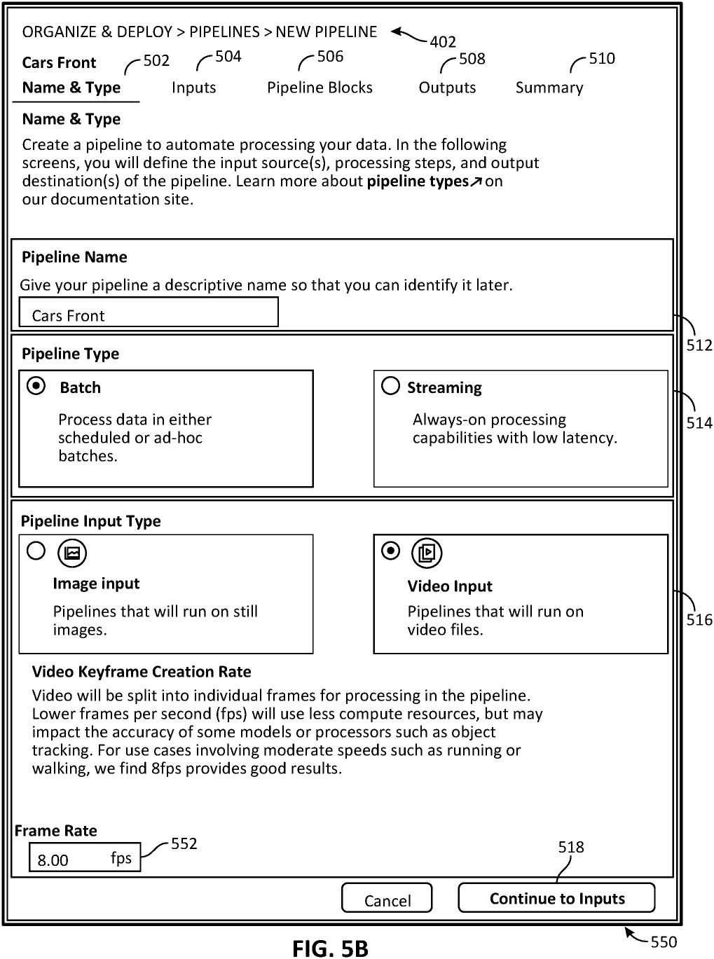

Returning to FIG. 3, at step 304, the user interface module 204 receives a computer vision pipeline type. The computer vision pipeline type may be either batch or streaming. A batch type computer vision pipeline receives input images and/or video from the input source system 108 according to a processing schedule or on an on-demand basis. A streaming computer vision pipeline type continually receives input images and/or video from the input source system 108, that is, on a continual basis. FIG. 5A depicts an example interface 500 for receiving a computer vision pipeline name, a computer vision pipeline type, and a computer vision pipeline input type in some embodiments. The interface 500 includes multiple text labels that indicate to the user where the user is at in the process of creating a computer vision pipeline. The multiple text labels include a name and type text label 502, an inputs text label 504, a pipeline blocks text label 506, an outputs text label 508, and a summary text label 510. The user may select a text label to navigate between different interfaces that the display module 206 displays.

The interface 500 includes a computer vision pipeline name section 512 where the user may specify a name of the computer vision pipeline, a computer vision pipeline type section 514 where the user may specify a computer vision pipeline type, and a computer vision pipeline input type section 516 where the user may specify a computer vision pipeline input type. The computer vision pipeline type section 514 allows the user to select either a batch type for the computer vision pipeline or a streaming type for the computer vision pipeline. If the user selects the batch type for the computer vision pipeline type, the computer vision pipeline system 104 will receive and process input images and/or video from the input source system 108 according to a processing schedule or on an on-demand basis. If the user selects the streaming type for the computer vision pipeline type in the computer vision pipeline type section 514, the computer vision pipeline system 104 will continually receive and process images and/or video from the input source system 108, that is, on a continual basis. If the user selects an image input for the computer vision pipeline input type in the computer vision pipeline input type section 516, the computer vision pipeline system 104 will receive and process images from the input source system 108. If the user selects a video input for the computer vision pipeline input type in the computer vision pipeline input type section 516, the computer vision pipeline system 104 will receive and process video from the input source system 108. In some embodiments, the computer vision pipeline input type section 516 includes a combined image and video input option. In such embodiments, the computer vision pipeline system 104 may receive and process both images and/or video from the input source system 108. The user can select a button 518 labeled “Continue to Inputs” or the inputs text label 504 to continue to an interface where the user may specify the input source system 108.

FIG. 5B depicts another example interface 550 for receiving a computer vision pipeline name, a computer vision pipeline type, and a computer vision pipeline input type in some embodiments. If the user selects a video input for the computer vision pipeline input type in the computer vision pipeline input type section 516, the interface 550 provides a frame rate selector 552. The user may specify a frame rate, in terms of frames per second (fps), that the computer vision pipeline system 104 will use to split video into individual frames (or images) for processing in the computer vision pipeline. In some embodiments a frame rate of eight fps may be used for tracking objects moving at or below moderate speeds, such as the average speed of a human walking or running.

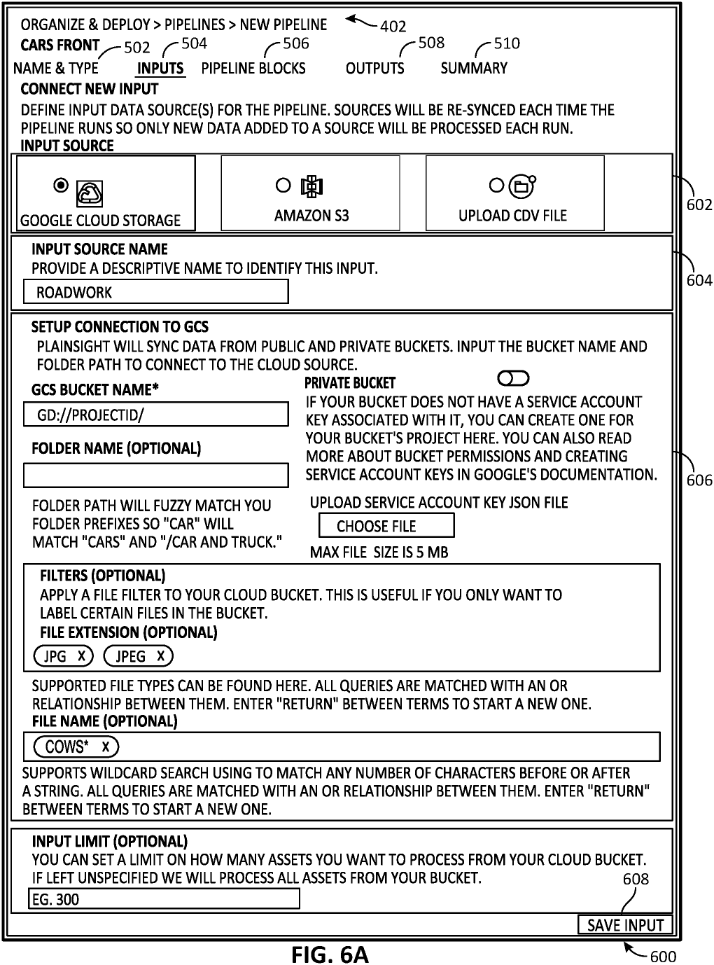

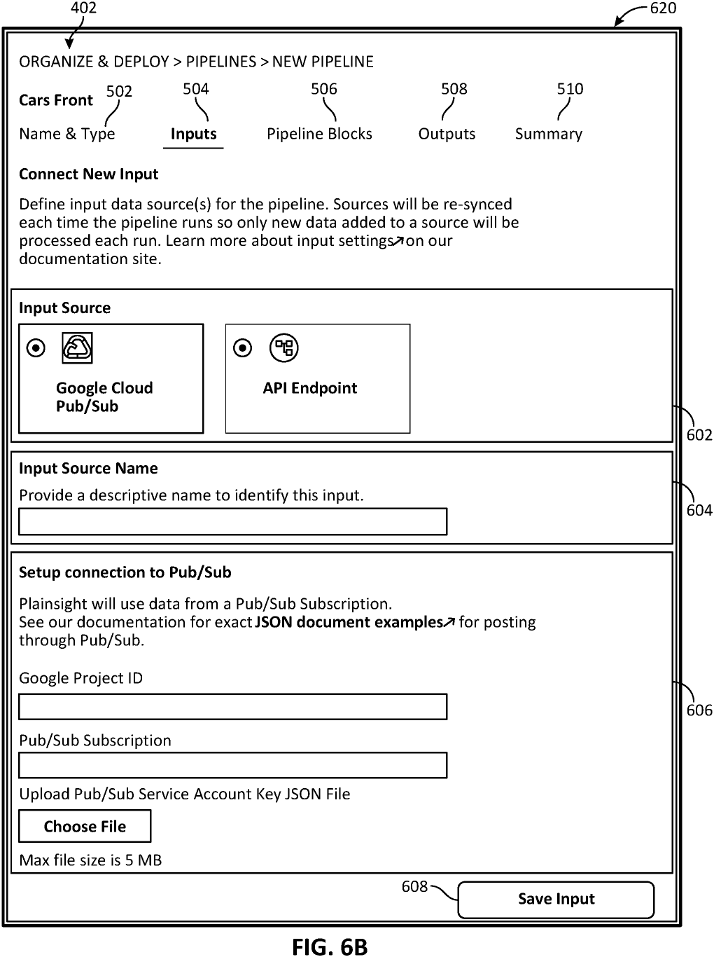

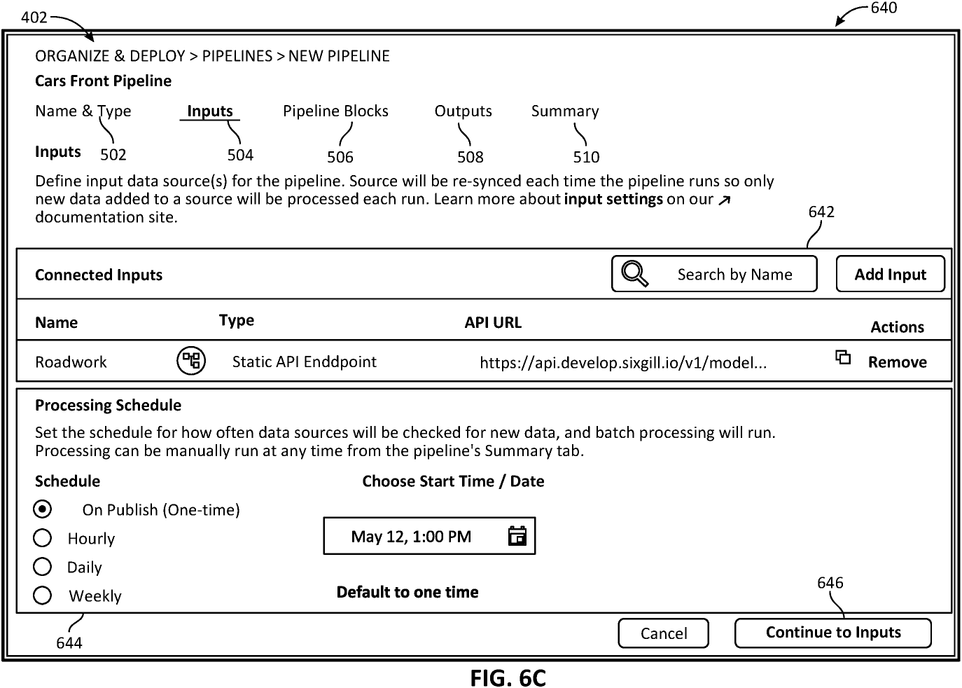

Returning to FIG. 3, at step 306 the user interface module 204 receives an input source for images and/or video for the computer vision pipeline, and optionally, a processing schedule if the computer vision pipeline type is the batch type. FIG. 6A depicts an example interface 600 for receiving an input source for images and/or video for a computer vision pipeline in some embodiments. The interface 600 includes a computer vision pipeline input source section 602, a computer vision pipeline input source name section 604, and a computer vision pipeline input source configuration section 606. The user may specify the input source in computer vision pipeline input source section 602, which may be or include a cloud storage provider such as Google Cloud Storage and Amazon S3. The input source may also be or include local data storage, such as video and/or images stored on the user system 106, or a file, such as a comma-separated-values (CSV) file, that includes pointers to stored video and/or images. The user may specify an input source name in the computer vision pipeline input source name section 604 and provide configuration information for the input source in the computer vision pipeline input source configuration section 606. Such configuration information may include a name of a particular bucket in a cloud storage provider, a folder name, and access information if the particular bucket is private. Such configuration information may also include filters to include only images and/or video with a specific extension or whose filenames match a wildcard search, as well as an input limit to specify a maximum number of images and/or video to be processed. The user can select a button 608 labeled “Save Input” to save the specified information for the input source.

FIG. 6B depicts another example interface 620 for receiving an input source for images and/or video for a computer vision pipeline in some embodiments. The interface 620 includes the computer vision pipeline input source section 602, the computer vision pipeline input source name section 604, and the computer vision pipeline input source configuration section 606. The user may specify the input source in computer vision pipeline input source section 602, which may be or include a messaging service such as Google Pub/Sub or an application programming interface (API) endpoint. The user may specify an input source name in the computer vision pipeline input source name section 604 and provide configuration information for the input source in the computer vision pipeline input source configuration section 606. Such configuration information may include a messaging service project ID, a messaging service subscription, an account key, and/or other information for configuring the messaging service or the API endpoint.

FIG. 6C depicts an example interface 640 for receiving a computer vision pipeline processing schedule in some embodiments. The display module 206 displays the interface 640 if the computer vision pipeline type is the batch type. The interface 640 includes a connected inputs section 642 in which one or more input sources are listed. The user may add input sources, search for input sources, edit input sources, and remove input sources in the connected inputs section 642. The interface 640 also includes a processing schedule section 644 in which the user may set a processing schedule for the computer vision pipeline. The processing schedule may be upon activation of the computer vision pipeline, or on an hourly, daily, or weekly basis. The user may also choose the start date and time for the computer vision pipeline. After specifying the processing schedule, the user may select the button 646 labeled “Continue to Pipeline Blocks” to select blocks for the computer vision pipeline.

Returning to FIG. 3, at step 308 the display module 206 displays a user interface element into which a block for a computer vision pipeline may be dragged and dropped. At step 310 the display module 206 displays multiple blocks for selection by the user. The multiple blocks include multiple image transformation blocks and multiple prediction blocks. A block may adhere to a convention of receiving images and/or video and data (for example, JavaScript object notation (JSON) files) and producing images and/or videos and data (for example, JSON files). This convention may allow users to place blocks anywhere within computer vision pipelines.

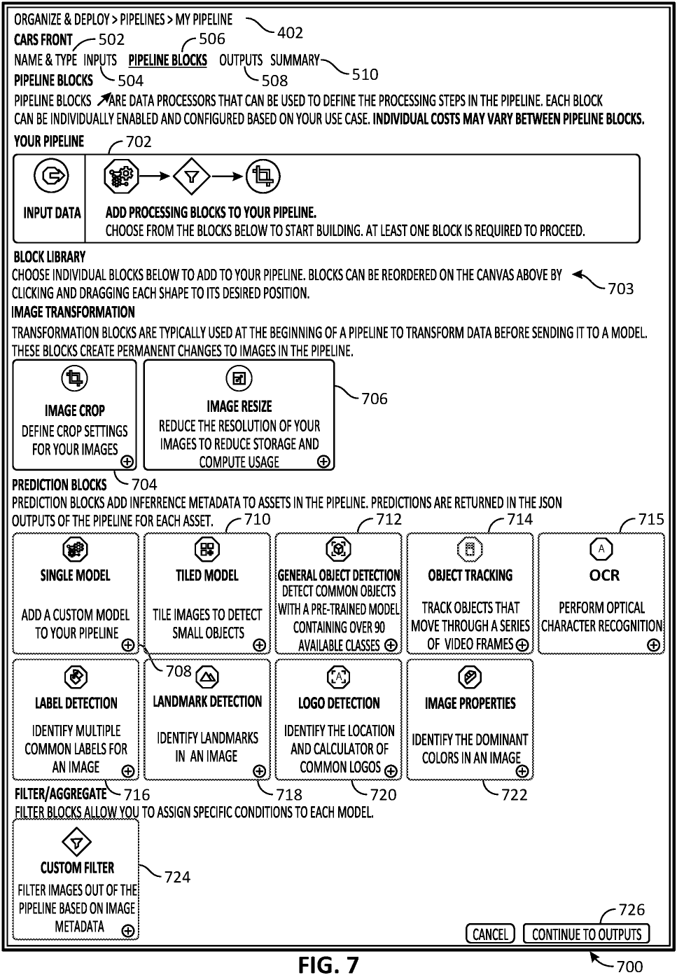

FIG. 7 depicts an example interface 700 for receiving selections of blocks for a computer vision pipeline in some embodiments. The interface 700 includes a user interface element 702 and a block library section 703. The block library section 703 includes multiple blocks, including multiple image transformation blocks. An image transformation block transforms images and/or video to produce transformed images and/or video. The multiple image transformation blocks include an image crop block 704 that crops images and/or video and an image resize block 706 that resizes images and/or video.

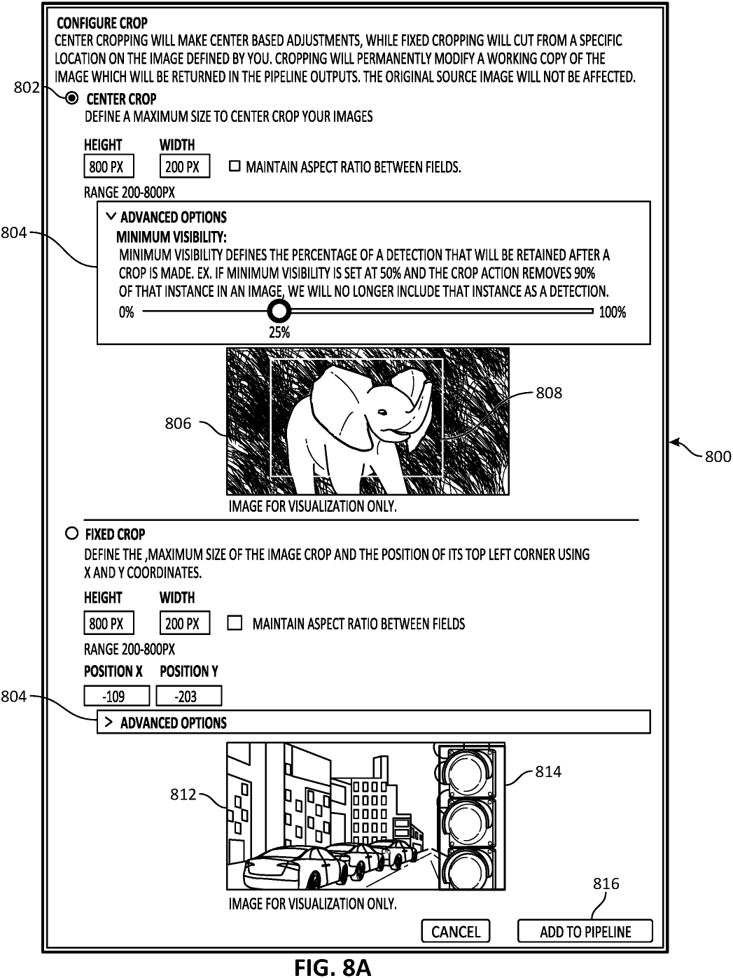

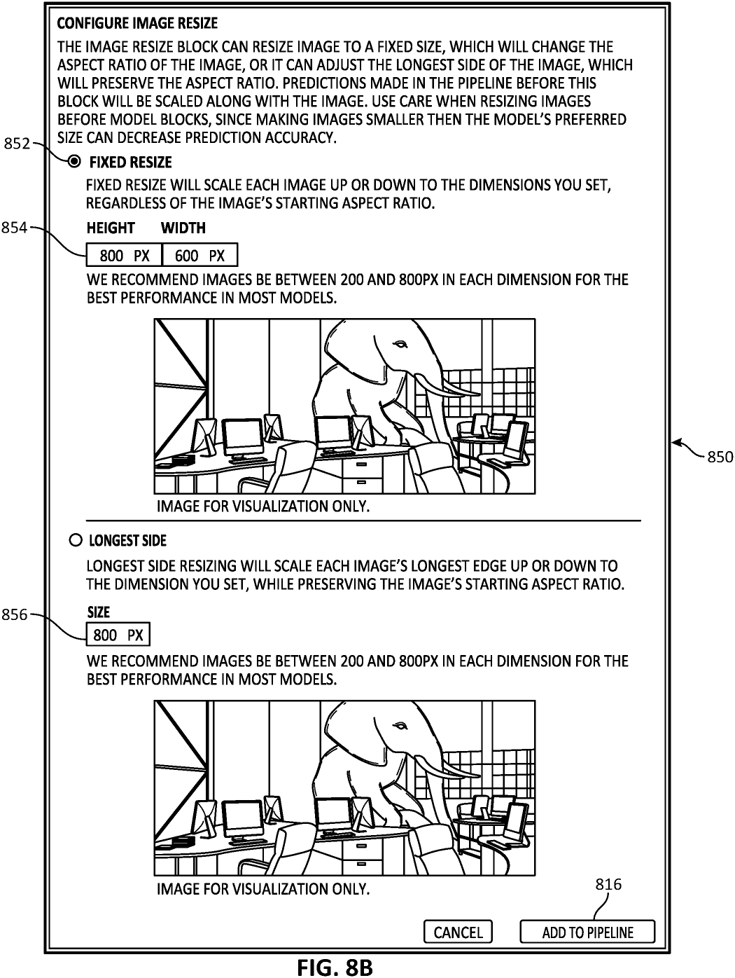

Returning to FIG. 3, at step 312 the user interface module 204 receives a selection of one or more blocks and configuration information for the selected one or more blocks. The user may select a block by dragging and dropping a block from the block library section 703 into the user interface element 702. The user may also select a block by selecting the plus icon in the lower right-hand corner of the block. FIG. 8A depicts an example interface 800 for receiving configuration information for the image crop block 704. The display module 206 displays the interface 800 if the user selects the image crop block 704. The interface 800 allows the user to specify whether the image crop block 704 should center crop images and/or video or fixed crop images and/or video. The radio button 802 allows the user to specify that the image crop block 704 should center crop or fixed crop images and/or video. If the user selects center crop, the user may specify the height and width of the cropped images and/or video. The user may also specify a minimum visibility for a detection after cropping in section 804. Image 806 includes a crop box 808 indicating the portion of the image that will remain after the image crop block performs center cropping. If the user selects fixed crop, the user may specify the height and width of the cropped images and/or video and the position at which the image crop block 704 should fixed crop images and/or video. Image 812 includes a crop box 814 indicating the portion of the image that will remain after the image crop block performs fixed cropping. The user may select the button 816 labeled “Add to Pipeline” to have the image crop block 704 with the specified configuration information added to the computer vision pipeline.

One advantage of cropping images using the image crop block 704 is that certain images may be too large to fit into memory of a GPU (graphical processing unit). Typically, such images may be resized in order to fit into GPU memory. However, resizing an image results in a loss of image resolution, which may make it more difficult to detect objects or classes of objects in the image. The image crop block 704 may center crop or fixed crop images and/or video, which may permit the cropped images and/or video to fit into GPU memory.

FIG. 8B depicts an example interface 850 for receiving configuration information for the image resize block 706 that resizes images and/or video. Images and/or video may be resized to reduce size without losing spatial relationship information. The image resize block 706 may use algorithmic approaches such as nearest neighbor interpolation or Lanczos resampling. The display module 206 displays the interface 850 if the user selects the image resize block 706. The interface 850 allows the user to specify whether the image resize block 706 should perform a fixed resize of images and/or video, which scales an image to set dimensions, or a longest side resizing, which scales the longest edge to the set dimension while preserving the image and/or video’s starting aspect ratio, using radio button 852. For a fixed resize, the user may specify the height and width of the resized image via inputs 854. For a longest side resize, the user may specify the size of the longest side via input 856. The user may select the button 816 to have the image resize block 706 with the specified configuration information added to the computer vision pipeline.

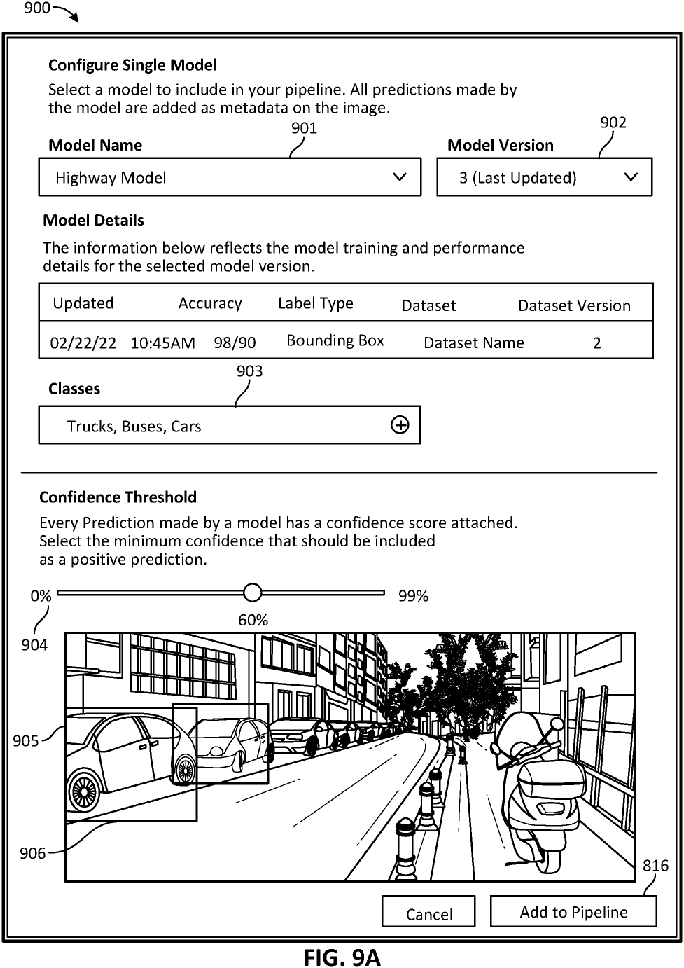

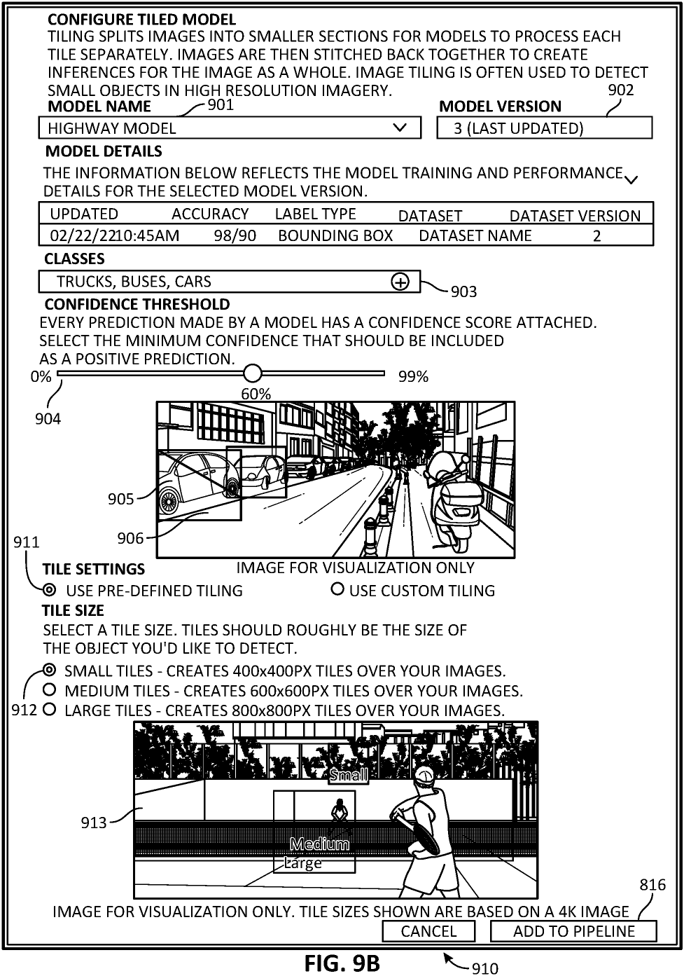

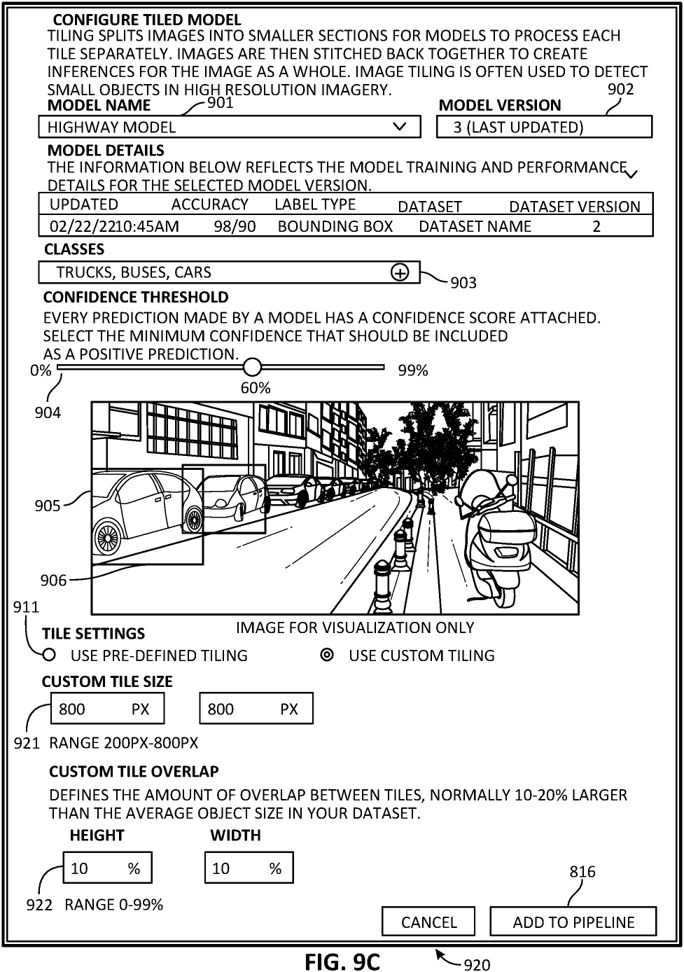

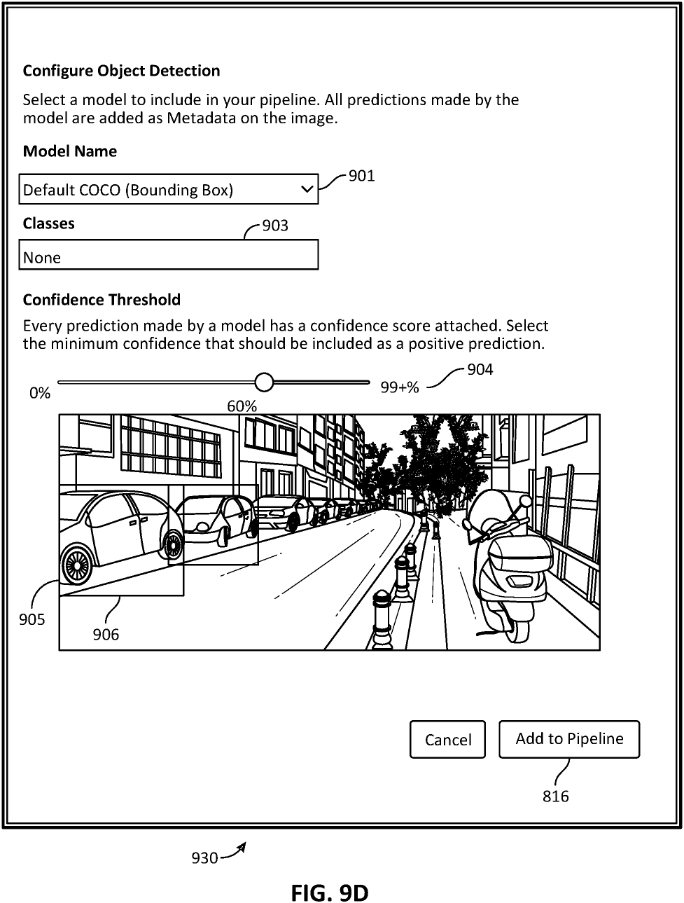

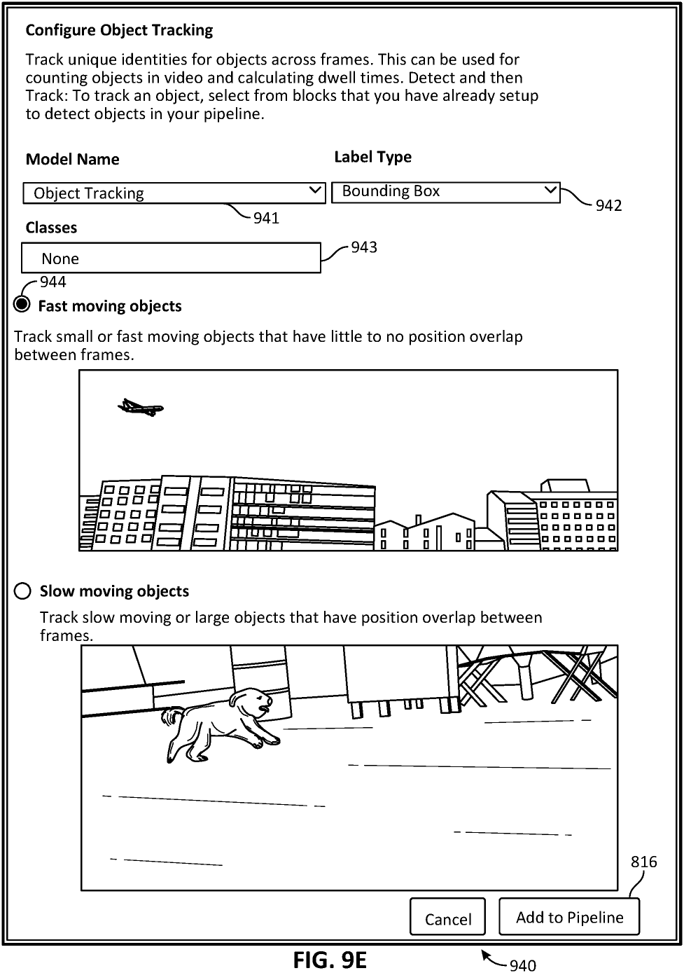

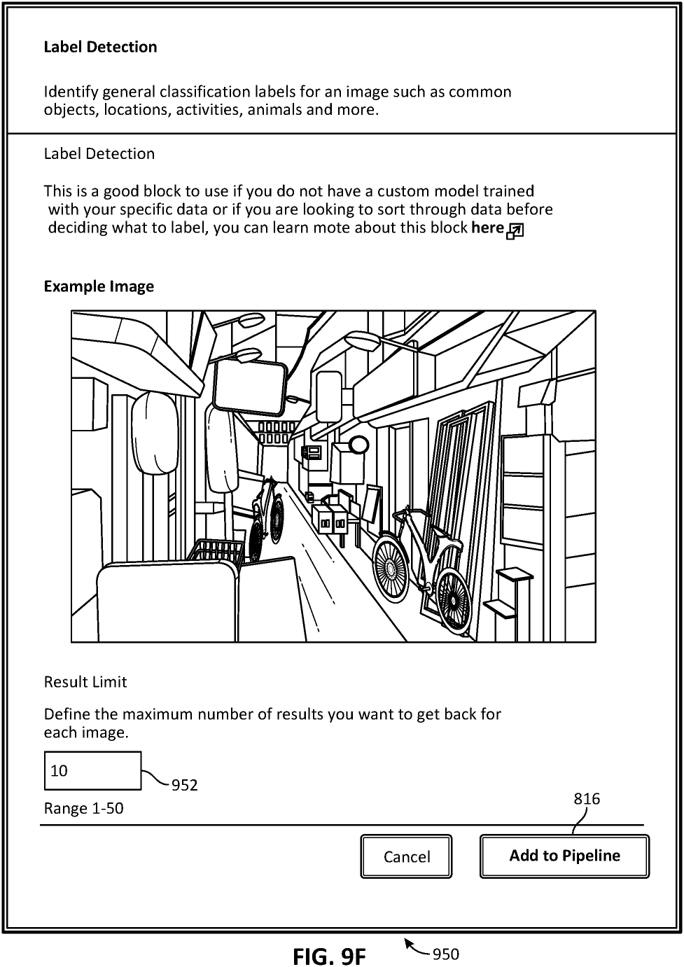

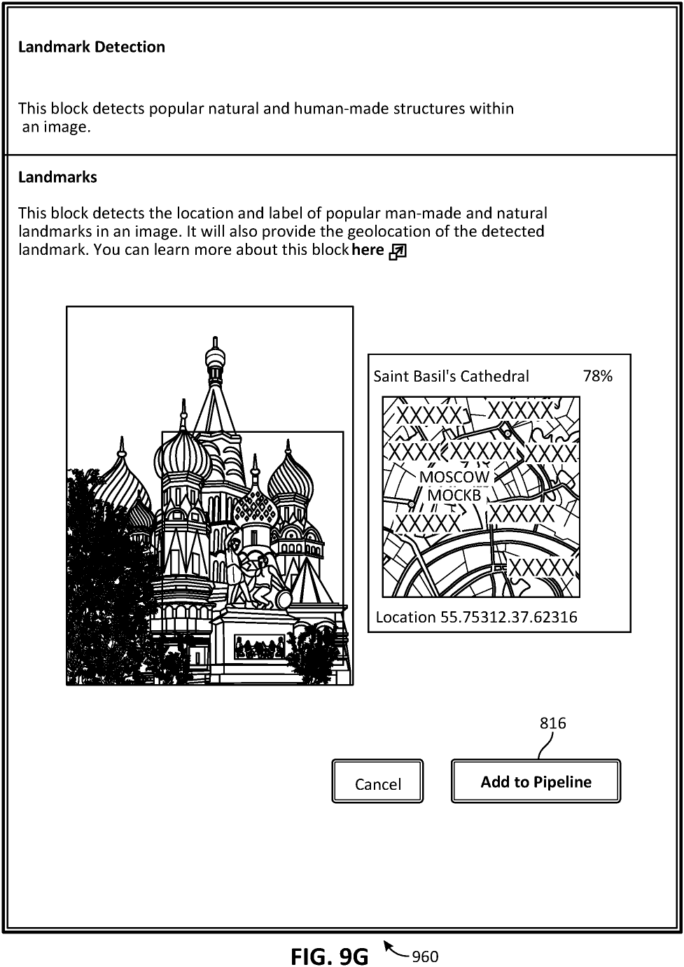

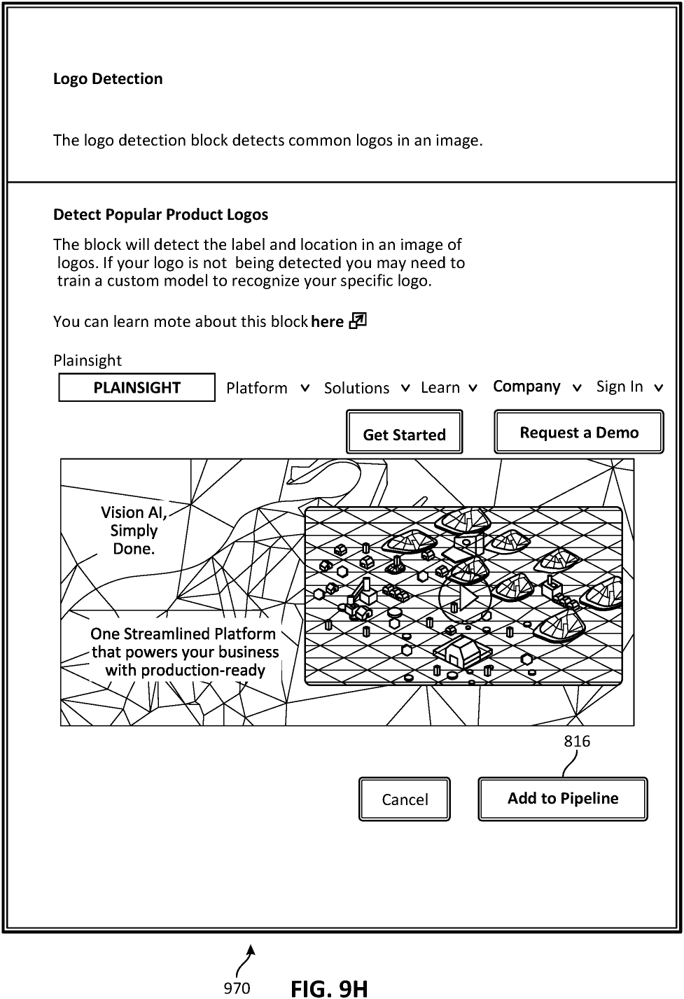

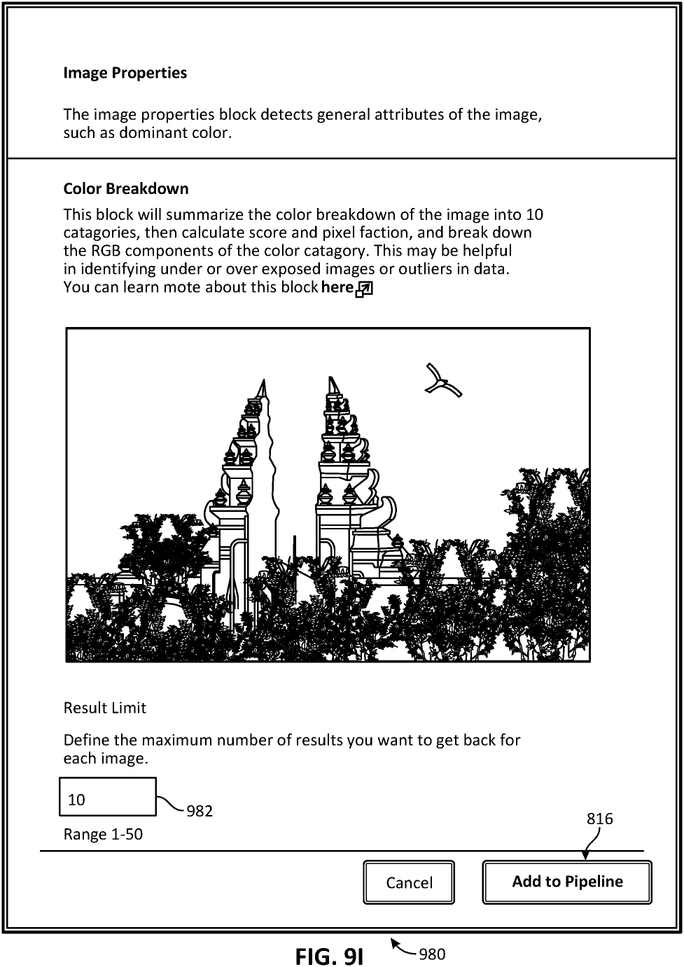

In addition to multiple image transformation blocks, the block library section 703 (FIG. 7) includes multiple prediction blocks. A prediction block detects objects or classes of objects in images and/or video and produces detected objects or classes of objects. The multiple prediction blocks include a single model block 708, a tiled model block 710, a general object detection block 712, an object tracking block 714, an optical character recognition block 715, a label detection block 716, a landmark detection block 718, a logo detection block 720, and an image properties block 722. FIG. 9A depicts an example interface 900 for receiving configuration information for the single model block 708 in some embodiments. The interface 900 includes a selector 901 that allows a user to select a machine learning model and a selector 902 for selecting a version of the machine learning model. The interface 900 also includes a selector 903 that allows a user to select classes of objects for the single model block 708 to detect in images and/or video. The interface 900 also includes a confidence threshold slider 904 that allows the user to specify the minimum confidence to be included as a positive detection. The image 905 includes multiple cars and the number of bounding boxes 906 around cars changes depending on the specified minimum confidence. The user may select the button 816 to have the single model block 708 with the specified configuration information added to the computer vision pipeline.

FIG. 9B depicts an example interface 910 for receiving configuration information for the tiled model block 710 in some embodiments. The tiled model block 710 splits images and/or video into multiple images for detection of objects or classes of objects, detects objects or classes of objects in the multiple images, recombines the multiple images to produce transformed images and/or video, and produces the transformed images and/or videos and detections of objects or classes of objects. The user may select a tiled model block 710 to detect small objects in high-resolution imagery, such as satellite imagery. Typical models may fail to detect very small objects in such imagery. The tiled model block 710 may utilize a sliding window pattern with a fixed tile size to sweep across images and/or video and perform detections at a much lower resolution.

The interface 910 has the same elements as the interface 900 of FIG. 9A. The interface 910 also has a radio button 911 that allows the user to specify that the tiled model block 710 is to use either pre-defined tiling or custom tiling. If the user selects pre-defined tiling, the user can specify a tile size using a radio button 912. The image 913 includes a small tile, a medium tile, and a large tile. FIG. 9C depicts another example interface 920 for receiving configuration information for the tiled model block 710 in some embodiments. In the interface 920, selection of custom tiling via the radio button 911 causes the display module 206 to display a custom tile size input 921 and a custom tile overlap input 922. In either the interface 910 or the interface 920, the user may select the button 816 to have the tiled model block 710 with the specified configuration information added to the computer vision pipeline.

FIG. 9D depicts an example interface 930 for receiving configuration information for the general object detection block 712 in some embodiments. The user may select a model using the selector 901 and classes using the selector 903. The general object detection models may be pre-trained models that can be used for detecting numerous classes of common objects, such as 80 or more classes (for example, airplane, person, sandwich classes). The general object detection models may be trained on a COCO dataset, which is a dataset format that supports labeling objects using feature points, rectangles, and polygons. The user may select the button 816 to have the general object detection block 712 with the specified configuration information added to the computer vision pipeline.

FIG. 9E depicts an example interface 940 for receiving configuration information for the object tracking block 714 in some embodiments. Object tracking includes the ability to create and track object track object identities across video frames. Object tracking is generally highly configurable and may need to be tuned to the particular video data because of differences in frame rate, object speed, performance requirements, and similarity of objects observed. Object tracking performance may be measured by how well an object is tracked by assigning the object the correct identity across video frames. Object tracking may use polygons with intersection over union (IoU) to track certain objects, such as animals. The interface 940 includes a selector 941 that allows the user to select a model for the object tracking block 714 to use, a selector 942 for selecting a label type, either bounding box or polygon, and a selector 943 for selecting the classes of objects that the object tracking block 714 will detect. The user can also specify using radio button 944 whether to track fast-moving objects or slow-moving objects. The user may select the button 816 to have the object tracking block 714 with the specified configuration information added to the computer vision pipeline.

FIG. 9F depicts an example interface 950 for receiving configuration information for the label detection block 716 in some embodiments. The label detection block 716 detects objects in images and/or video and produces one or more label descriptions for the detected objects. In some embodiments, the label detection block 716 uses an API of a third-party system, such as the Label Detection Google Cloud Vision API, to detect objects in image and/or video such as products, animal species, scenes, locations, actions, and activities. The label detection block 716 returns a label description and confidence scores for detected objects. The interface 950 includes an input 952 that allows the user to specify a maximum number of detections for each image and/or video. The user may select the button 816 to have the label detection block 716 with the specified configuration information added to the computer vision pipeline.

FIG. 9G depicts an example interface 960 for receiving configuration information for the landmark detection block 718 in some embodiments. The landmark detection block 718 detects landmarks such as iconic architectures, historic artifacts, or natural structures. The landmark detection block 718 returns the detected landmark entity description, the bounding box, and the location coordinates. In some embodiments, the landmark detection block 718 uses an API of a third-party system, such as the Detect Landmarks Google Cloud Vision API, to detect landmarks in image and/or video. Although not depicted in FIG. 9G, the interface 960 may include input that allows the user to specify a maximum number of detections for each image and/or video. The user may select the button 816 to have the landmark detection block 718 with the specified configuration information added to the computer vision pipeline.

FIG. 9H depicts an example interface 970 for receiving configuration information for the logo detection block 720 in some embodiments. The logo detection block 720 detects logos, such as product or company logos, in images and/or video and returns a detected logo description. In some embodiments, the logo detection block 720 uses an API of a third-party system, such as the Detect Logos Google Cloud Vision API, to detect logos in image and/or video. Although not depicted in FIG. 9H, the interface 970 may include input that allows the user to specify a maximum number of detections for each image and/or video. The user may select the button 816 to have the logo detection block 720 added to the computer vision pipeline.

FIG. 9I depicts an example interface 980 for receiving configuration information for the image properties block 722 in some embodiments. The image properties block 722 detects properties and/or attributes of images and/or video such as colors. The interface 980 includes an input 982 that allows the user to specify a maximum number of results for images and/or video. The image properties image properties block 722 summarizes a color breakdown of the images and/or video into the desired number of dominant colors as specified by the input 982. In some embodiments, the image properties image properties block 722 uses an API of a third-party system, such as the Detect Image Properties Google Cloud Vision API, to detect the key properties and/or attributes of images and/or video.

Returning to FIG. 7, the optical character recognition block 715 may be used to perform optical character recognition (OCR) to detect characters, such as letters and numbers, in images and/or video. The block library section 703 also includes a custom filter block 724. The custom filter block 724 allows a user to specify specific conditions to be performed between other blocks of the computer vision pipeline. For example, the user may specify that only images and/or video for which cars have been detected should continue to the next block in the computer vision pipeline.

The computer vision pipeline system 104 may include blocks other than the blocks described with reference to, for example, FIGS. 7-10. Such blocks may include a two-stage block that includes two models working in series. Another block may be a distortion block that corrects for fisheye lenses. Another block may be a person de-identification block that blurs or otherwise obscures faces and/or entire bodies of humans. Another block may be a scene detection block that detects which scene a frame of a video is in, which may be useful for movies or other edited video. Another block may be a motion detection block that determines if there is motion within a particular frame of video.

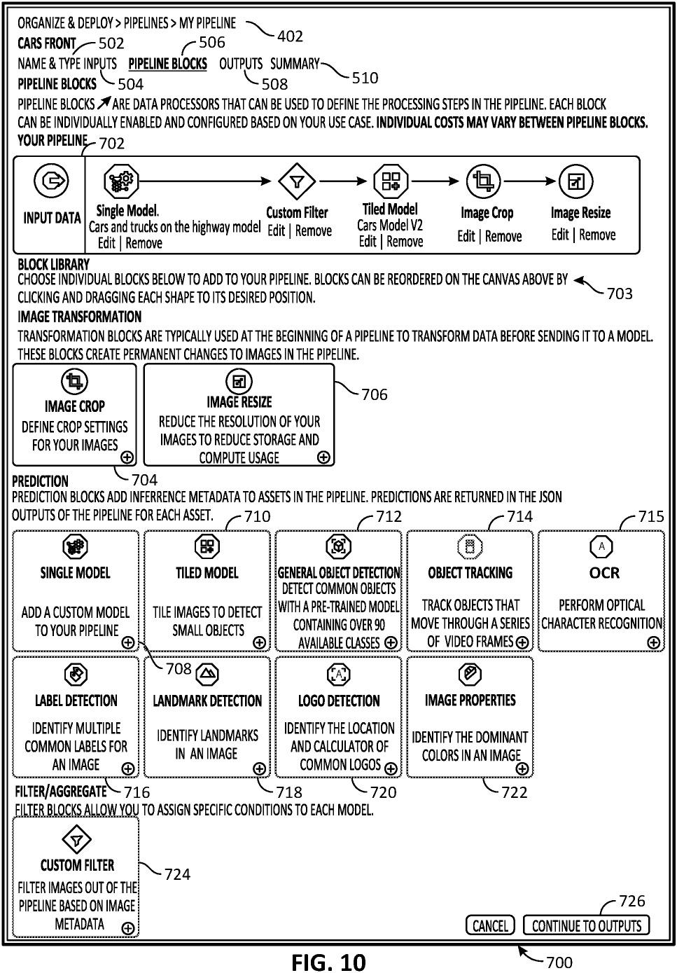

Returning to FIG. 3, at step 314 the computer vision pipeline creation module 208 adds the selected blocks to the computer vision pipeline. FIG. 10 depicts the example interface 700 of FIG. 7 with multiple blocks added to the computer vision pipeline in some embodiments. After the user has finished having blocks added to the computer vision pipeline, the user may select a button 726, labeled “Continue to Outputs” to continue to an interface for selecting an output destination for the computer vision pipeline. Returning to FIG. 3, at step 316 the user interface module 204 receives an output destination.

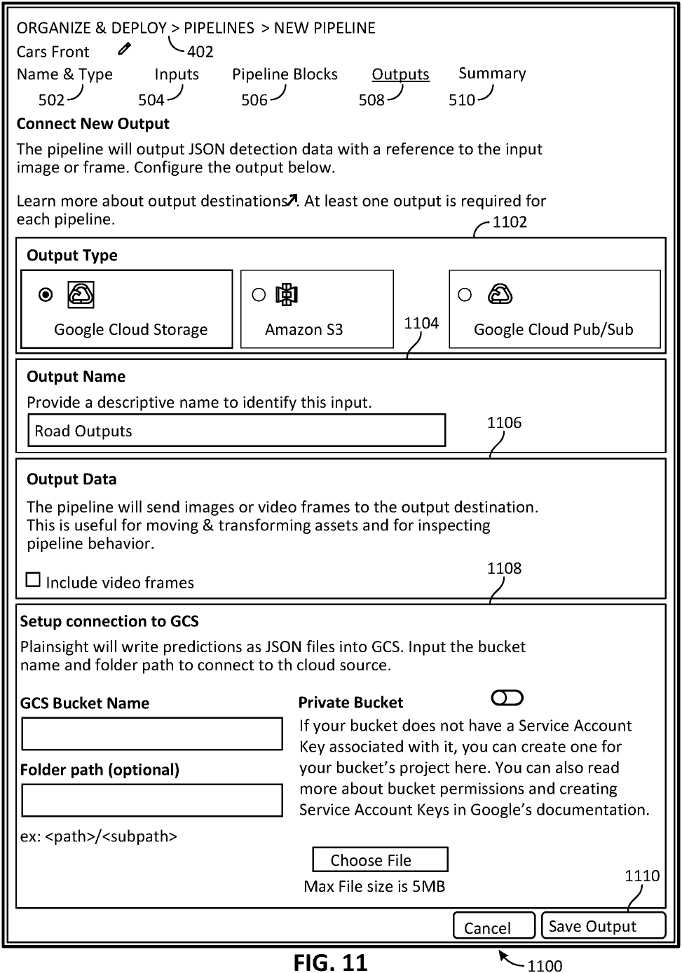

FIG. 11 depicts an example interface 1100 for receiving an output destination for a computer vision pipeline in some embodiments. The interface 1100 includes an output type section 1102 that allows the user to select an output destination and an output name 1104 section that allows the user to specify an output destination name. The interface 1100 also includes an output data section 1106 that allows the user to specify whether the computer vision pipeline system 104 should send images and/or video to the output destination and a configuration section 1108 that allows the user to specify configuration information for the output destination. Such configuration information may include a name of a particular bucket in a cloud storage provider, a folder name, and access information if the particular bucket is private. After providing an output destination, the user may select the button 1110, labeled “Save Output” to save the output destination and proceed to a summary interface.

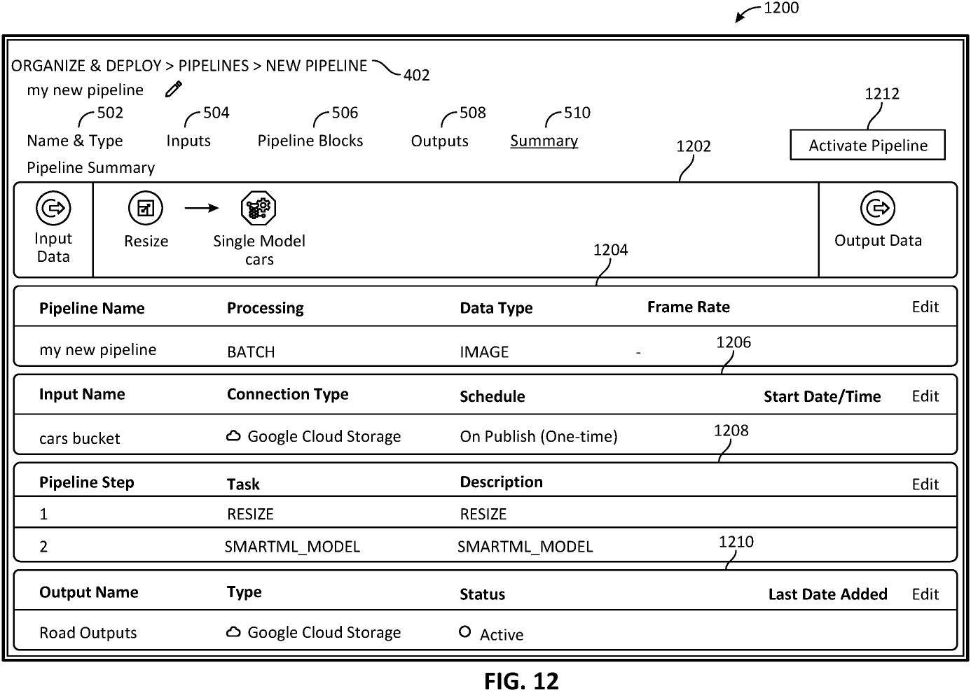

FIG. 12 depicts an example interface 1200 for displaying a summary of a computer vision pipeline and for receiving a request to activate a computer vision pipeline in some embodiments. The interface 1200 includes a computer vision pipeline summary section 1202 that displays the blocks in the computer vision pipeline and a pipeline details section 1204 that displays the computer vision pipeline name, computer vision pipeline type, the data type, and the computer vision pipeline frame rate if the computer vision pipeline type is video. The interface 1200 also includes an input source section 1206 that displays details as to the computer vision pipeline input source, a block section 1208 that displays details as to the blocks in the computer vision pipeline, and an output destination section 1210 that displays details as to the computer vision pipeline output destination. Each section has a text link with the label “Edit” that allows the user to edit the configuration for that particular section. The interface 1200 also includes a button 1212 labeled “Activate Pipeline.” Upon selection by a user, the user interface module 204 receives the request to activate the computer vision pipeline, which is step 318 of FIG. 3, and the computer vision pipeline activation module 210 activates the computer vision pipeline, which is step 320 of FIG. 3. After activation, the computer vision pipeline running module 216 may begin running the computer vision pipeline.

In various embodiments, the computer vision pipeline running module 216 may utilize an application programming interface (API) to run the computer vision pipeline. The API may support multiple image and video data types, multiple pipeline types such as batch or streaming (or edge in some embodiments), multiple input sources such as cloud storage buckets and messaging services, and multiple output destinations such as cloud storage buckets and messaging services. The computer vision pipeline running module 216 may translate computer vision pipelines into a directed acyclic graph (DAG), such as an Apache Beam-based DAG, to run the computer vision pipeline. The computer vision pipeline running module 216 may create a uniform resource locator (URL) for each image and/or video frame as a signed URL and pass the signed URL to a queue. The computer vision pipeline running module 216 may then distribute signed URLS out of the queue to multiple digital devices working in parallel. The multiple digital devices may transform images and/or video and detect objects or classes of objects in parallel and write detections into JSON files. The multiple digital devices may then transmit the output to the output destination system 110 destination.

Returning to FIG. 3, at step 322 the communication module 202 receives input images and/or video from the input source system 108. At step 324, the image transformation module 212 causes an image transformation block, if the computer vision pipeline contains an image transformation block, to transform images and/or video and to produce transformed images and/or video. Also at step 324, the object and class detection module 214 causes a prediction block, if the computer vision pipeline contains a prediction block, to detect objects or classes of objects in images and/or video and to produce detected objects or classes of objects. At step 326 the communication module 202 transmits the detected objects or classes of objects to the output destination system 110. At step 328 the communication module 202 transmits the transformed images and/or video to the output destination system 110.

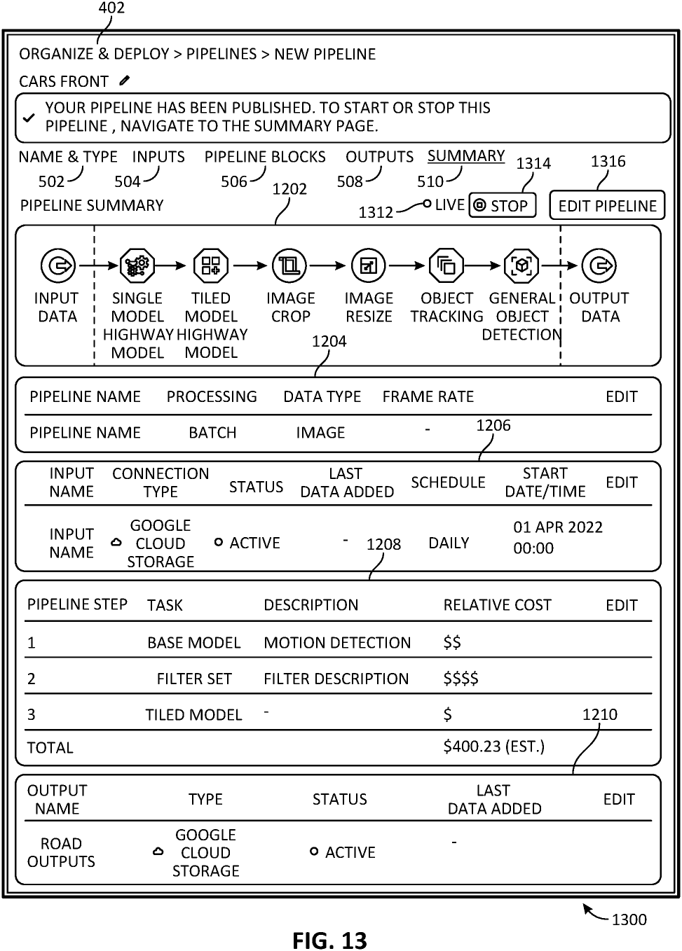

At step 330, the display module 206 displays a summary of the computer vision pipeline. FIG. 13 depicts an example interface 1300 for displaying a summary of a computer vision pipeline and for receiving a request to modify a computer vision pipeline in some embodiments. The interface 1300 is generally similar to the interface 1200 of FIG. 12. The block section 1208 may include relative costs for blocks of the computer vision pipeline and an estimated cost to run the computer vision pipeline. The interface 1300 also includes an indicator 1312 indicating a status of the computer vision pipeline, a button 1314 labeled “Stop” that allows the user to request that the computer vision pipeline running module 216 stop running the computer vision pipeline, and a button 1316 labeled “Edit Pipeline” that allows the user to request to make modifications to the computer vision pipeline. The user may select the button 1316 or the “Edit” text links in the interface 1300 to request to make modifications to the computer vision pipeline. Returning to FIG. 3, at step 332 the computer vision pipeline creation module 208 receives modifications to the computer vision pipeline. At step 334 the computer vision pipeline creation module 208 modifies the computer vision pipeline according to the requested modifications. At step 336 the display module 206 displays a summary of the computer vision pipeline and, optionally, other computer vision pipelines.

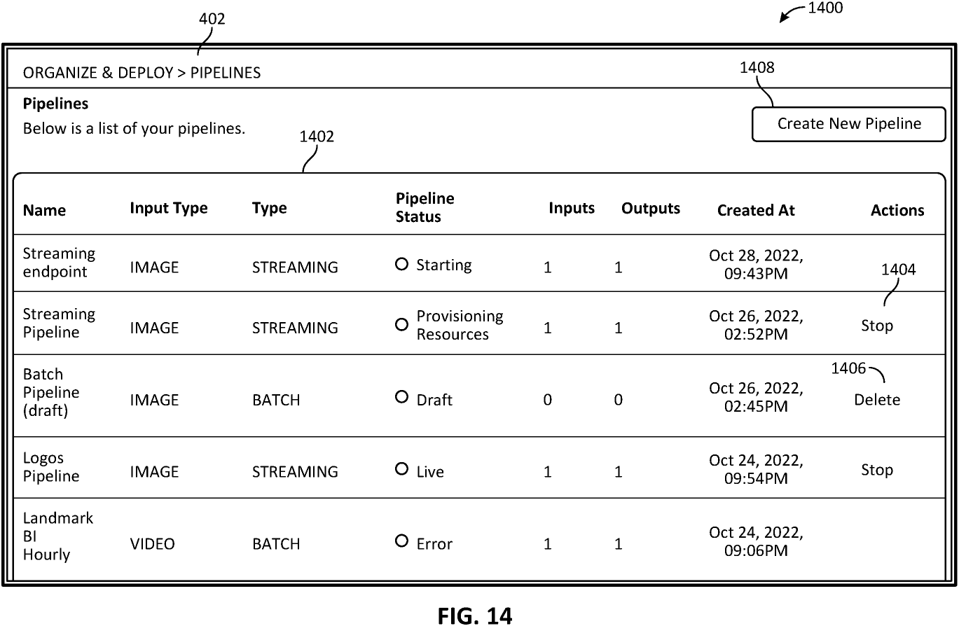

FIG. 14 depicts an example interface 1400 for displaying a summary of multiple computer vision pipelines in some embodiments. The interface 1400 includes a list section 1402 listing the computer vision pipelines that the user has created, their names, input types, types, status, number of inputs and number of outputs, creation date, and actions. The list section 1402 includes a text link 1404 labeled “Stop” that allows a user to request that the computer vision pipeline running module 216 stop running a computer vision pipeline. The list section 1402 also includes a text link 1406 labeled “Delete” that allows a user to request that the computer vision pipeline creation module 208 delete a computer vision pipeline. The interface 1400 also includes a button 1408 labeled “Create New Pipeline” that allows a user to request to create a new computer vision pipeline.

An example use case of the computer vision pipeline systems and associated methods described herein is as follows. Animal hides, which may be steer hides or cow hides, each have a tattoo (or similar, such as a brand) on the animal hide that includes numbers and letters. A camera may capture images and/or video of the animal hides. A user may request that the computer vision pipeline system 104 create a computer vision pipeline to process the captured images and/or video. The user may specify an input source of the images and/or video. The user may select a single model block 708 as a first block of the computer vision pipeline to detect the tattoo and identify a bounding box around the tattoo in the images and/or video. The user may select an image crop block 704 as a second block of the computer vision pipeline to crop the images and/or video to the bounding box (or slightly larger than the bounding box). The user may select the optical character recognition block 715 as a third block of the computer vision pipeline to perform OCR on the cropped images and/or video to detect characters in the cropped mages and/or video. The computer vision pipeline system 104 may then produce JSON files with the detected characters and transmit the JSON files, and optionally, the cropped images and/or video, to the output destination system 110. Human labelers may then manually verify the detected characters in the images and/or video. The user could use the computer vision pipeline system 104 in the described fashion to generate a ground truth dataset for further training of machine learning models and/or for other purposes. Additionally or alternatively, the user may select a single model block 708 that detects characters as a first block of the computer vision pipeline and an image crop block 704 that crops around the detected characters as a second block of the computer vision pipeline.

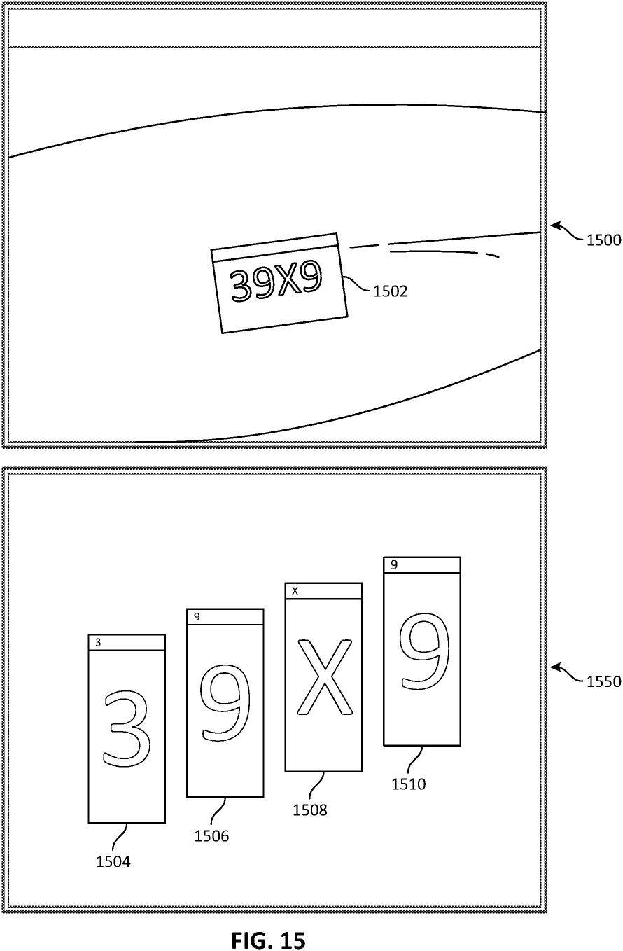

FIG. 15 depicts the example use of a computer vision pipeline in some embodiments. The communication module 202 has received an input image of an animal hide from the input source system 108. In FIG. 15, the image 1500 depicts a bounding box 1502 around a tattoo on an animal hide. The single model block 708 identified the bounding box 1502. The image crop block 704 then cropped the image 1500 to produce the image 1550. The image 1550 depicts four bounding boxes, a bounding box 1504 around the character “3”, a bounding box 1506 around the character “9”, a bounding box 1508 around the character “X”, and a bounding box 1510 around the character “9.” The optical character recognition block 715 detected each of the characters and identified a bounding box for each of the characters. The communication module 202 then transmits the detected characters to the output destination system 110.

Another example use case of the computer vision pipeline systems and associated methods described herein is as follows. Live animals may need to be tracked as they move, for example, in a pen, a field, or along a track. Similarly, animal carcasses may need to be tracked as they are moved, for example, by a conveyor belt, a hook, or other instrument. A camera may capture video of the live animals or animal carcasses. A user may request that the computer vision pipeline system 104 create a computer vision pipeline to process the captured video. The user may specify an input source of the video. The user may select a single model block 708 as a first block of the computer vision pipeline to detect the live animals or animal carcasses. The user may select the object tracking block 714 as a second block to track the live animals or animal carcasses across video frames. The computer vision pipeline system 104 may then produce JSON files with the tracked live animals or animal carcasses.

Another example use case of the computer vision pipeline systems and associated methods described herein is to detect persons, such as persons within stores, malls, and other facilities in images and/or video. Such detection may be performed so as to obtain occupancy counts. The general object detection block 712 may be utilized to detect persons as the general object detection block 712 includes a person class.

Another example use case of the computer vision pipeline systems and associated methods described herein is to detect insects on vegetation, such as whiteflies on leaves, in images and/or video. The tiled model block 710 may be utilized to split a high-resolution image of vegetation into multiple images, detect the insects in each image, and then recombine the images and aggregate the detections.

Another example use case of the computer vision pipeline systems and associated methods described herein is to detect license plates, such United States license plates. A two-stage block may be utilized to detect license plates in images and/or video. The first stage may crop a region of interest (ROI) in an image using a detection model. The second stage may be run on the cropped image. For example, a two-stage license plate detection block may first crop a ROI in an image using a license plate detection model, and may second run a model that detects license characters on the cropped image. The second stage may be modeled as a character detection problem with a subsequent algorithmic reconstruction, or a recurrent neural network (RNN) based model.

Another example use case of the computer vision pipeline systems and associated methods described herein is to quantify plant growth for different plant species. There may be a standardized plant growing environment with a fixed camera perspective. An image crop block 704 may be utilized to crop the image to the ROI. A single model block 708 may then be run to detect plants in the cropped image so as to be able to quantify growth of the plants.

Another example use case of the computer vision pipeline systems and associated methods described herein is to detect chess positions. A single model block 708 could detect a chess board in an image, then an image crop block 704 could crop the image to just the chess board. An image resize block 706 could resize the image to reduce the image resolution. The resized image could then be used for training or inference.

Another example use case of the computer vision pipeline systems and associated methods described herein is to detect food. A two-stage model may be utilized to detect a plate or bowl and then individual food items may be detected. It will be appreciated that other example use cases are within the scope of this disclosure.

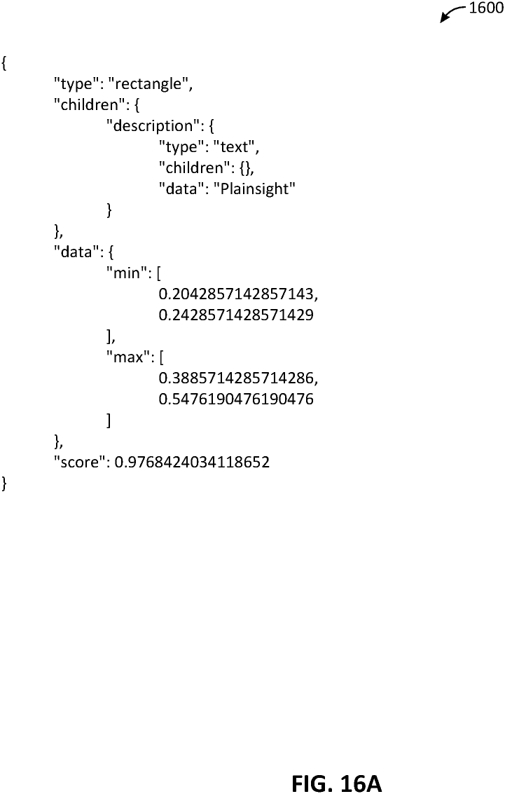

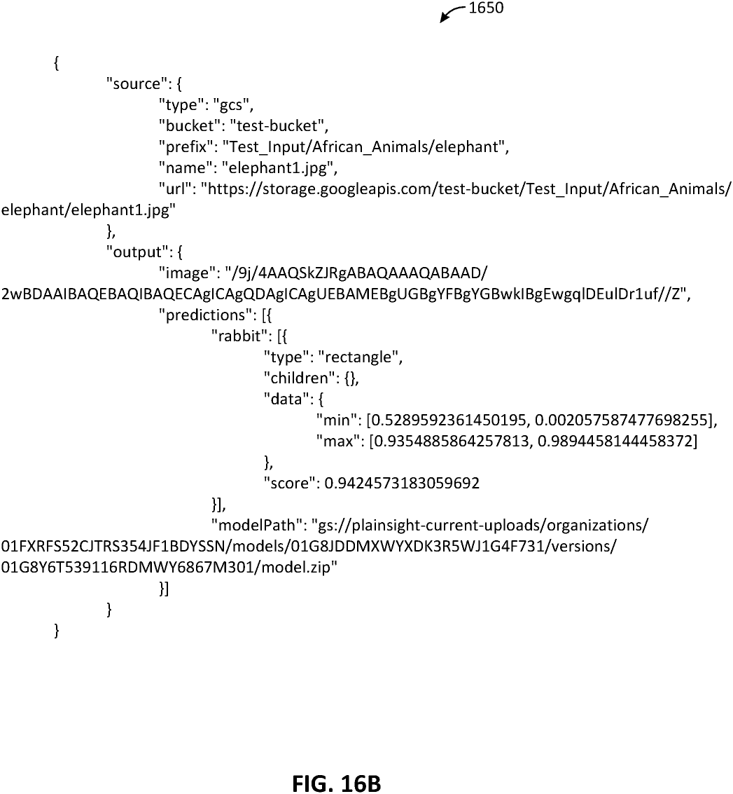

FIGS. 16A and 16B depicts an example output 1600 and an example output 1650, respectively, of prediction blocks in some embodiments. The output 1600 and the output 1650 may each be in a JSON (JavaScript Object Notation) file format. In some embodiments, the JSON file may have a convention of “image name”.extension.JSON. In FIG. 16A, the output 1600 may be from a logo detection block 720. The output 1600 includes a type of rectangle, indicating a bounding box. The output includes a children tag with data describing the detected logo. The data includes minimum and maximum XY coordinates. These minimum and maximum values define the boundaries of the rectangle. The XY coordinate values are relative (0.0 to 1.0) to width and height respectively. The score is a confidence score.

In FIG. 16B, the output 1650 may be from a general object detection block 712. The output 1650 includes source information and output information. The source information includes information about the input image. The output information includes an identifier of an output image and/or video as a base64-encoded string if the user selected to include output images and/or video when the user configured the output destination, or if an image transformation was performed on the image and/or video. The output information may also include a segmentation mask as a base64-encoded string. The output information also includes prediction data including a confidence score and a path to the model used for detections.

FIG. 17 depicts a block diagram of an example digital device 1700 according to some embodiments. The digital device 1700 is shown in the form of a general-purpose computing device. The digital device 1700 includes at least one processor 1702, RAM 1704, communication interface 1706, input/output device 1708, storage 1710, and a system bus 1712 that couples various system components including storage 1710 to the at least one processor 1702. A system, such as a computing system, may be or include one or more of the digital device 1700.

System bus 1712 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1700 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1702 is configured to execute executable instructions (for example, programs). In some embodiments, the at least one processor 1702 comprises circuitry or any processor capable of processing the executable instructions.

In some embodiments, RAM 1704 stores programs and/or data. In various embodiments, working data is stored within RAM 1704. The data within RAM 1704 may be cleared or ultimately transferred to storage 1710, such as prior to reset and/or powering down the digital device 1700.

In some embodiments, the digital device 1700 is coupled to a network, such as the communication network 112, via communication interface 1706. Still yet, the user system 106, the computer vision pipeline system 104, the output destination system 110, and/or the input source system 108 can communicate with one or more networks such as a local area network (LAN), a general wide area network (WAN), and/or a public network (for example, the Internet).

In some embodiments, input/output device 1708 is any device that inputs data (for example, mouse, keyboard, stylus, sensors, etc.) or outputs data (for example, speaker, display, virtual reality headset).

In some embodiments, storage 1710 can include computer system readable media in the form of non-volatile memory, such as read only memory (ROM), programmable read only memory (PROM), solid-state drives (SSD), flash memory, and/or cache memory. Storage 1710 may further include other removable/non-removable, volatile/non-volatile computer system storage media. By way of example only, storage 1710 can be provided for reading from and writing to a non-removable, non-volatile magnetic media. The storage 1710 may include a non-transitory computer-readable medium, or multiple non-transitory computer-readable media, which stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1712 by one or more data media interfaces. As will be further depicted and described below, storage 1710 may include at least one program product having a set (for example, at least one) of program modules that are configured to carry out the functions of embodiments of the invention. In some embodiments, RAM 1704 is found within storage 1710.

Programs/utilities, having a set (at least one) of program modules, such as the computer vision pipeline system 104, may be stored in storage 1710 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 1700. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled”, “couplable”, “operably coupled”, “communicably coupled” and the like to other components. Such description or illustration should be understood as indicating that such components may cooperate or interact with each other, and may be in direct or indirect physical, electrical, or communicative contact with each other.

Components may be described or illustrated as “configured to”, “adapted to”, “operative to”, “configurable to”, “adaptable to”, “operable to” and the like. Such description or illustration should be understood to encompass components both in an active state and in an inactive or standby state unless required otherwise by context.

It may be apparent that various modifications may be made, and other embodiments may be used without departing from the broader scope of the discussion herein. Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving a request to create a computer vision pipeline for processing images and/or video;
receiving an input source for images and/or video for the computer vision pipeline;
displaying multiple blocks for selection, the multiple blocks including multiple image transformation blocks, an image transformation block transforming images and/or video to produce transformed images and/or video, and multiple prediction blocks, a prediction block detecting objects or classes of objects in images and/or video to produce detected objects or classes of objects;
receiving a selection of an image transformation block and configuration information for the image transformation block;
adding the image transformation block to the computer vision pipeline;
receiving a selection of a prediction block and configuration information for the prediction block;
adding the prediction block to the computer vision pipeline;
receiving an output destination for the computer vision pipeline;
receiving a request to activate the computer vision pipeline;
activating the computer vision pipeline;
receiving input images and/or video from the input source;
transforming, using the image transformation block, the input images and/or video to produce transformed images and/or video;
detecting, using the prediction block, objects or classes of objects in the transformed images and/or video to produce detected objects or classes of objects; and
transmitting the detected objects or classes of objects to the output destination.

2. The non-transitory computer-readable medium of claim 1, the method further comprising displaying a user interface element into which a block may be dragged and dropped to select the block, and wherein receiving the selection of the image transformation block and configuration information for the image transformation block includes receiving a dragging and dropping of the image transformation block into the user interface element, and receiving the selection of the prediction block and configuration information for the prediction block includes receiving a dragging and dropping of the prediction block into the user interface element.

3. The non-transitory computer-readable medium of claim 1, the method further comprising:
receiving a computer vision pipeline type, the computer vision pipeline type being one of a batch type or a streaming type;
if the computer vision pipeline type is the batch type, receiving a processing schedule, wherein receiving input images and/or video from the input source includes receiving input images and/or video from the input source according to the processing schedule; and
if the computer vision pipeline type is a streaming type, wherein receiving input images and/or video from the input source includes continually receiving input images and/or video from the input source.

4. The non-transitory computer-readable medium of claim 1 wherein the multiple image transformation blocks include an image crop block that crops images and/or video and an image resize block that resizes images and/or video.

5. The non-transitory computer-readable medium of claim 1 wherein the multiple prediction blocks include a tiled model block that splits images and/or video into multiple images for detection of objects or classes of objects, detects objects or classes of objects in the multiple images, recombines the multiple images to produce transformed images and/or video, and produces the transformed images and/or videos and detections of objects or classes of objects.

6. The non-transitory computer-readable medium of claim 1 wherein the multiple prediction blocks include a label detection block that detects objects in images and/or video and produces one or more label descriptions for the detected objects, a landmark detection block that detects landmarks in images and/or video and produces a detected landmark description, and a logo detection block that detects logos in images and/or video and returns a detected logo description.

7. The non-transitory computer-readable medium of claim 1, the method further comprising displaying a summary of the computer vision pipeline, the summary including the input source, the image transformation block, the prediction block, an order of the image transformation block and the prediction block in the computer vision pipeline, and the output destination.

8. A system comprising at least one processor and memory containing instructions, the instructions being executable by the at least one processor to:
receive a request to create a computer vision pipeline for processing images and/or video;
receive an input source for images and/or video for the computer vision pipeline;
display multiple blocks for selection, the multiple blocks including multiple image transformation blocks, an image transformation block transforming images and/or video to produce transformed images and/or video, and multiple prediction blocks, a prediction block detecting objects or classes of objects in images and/or video to produce detected objects or classes of objects;
receive a selection of an image transformation block and configuration information for the image transformation block;
add the image transformation block to the computer vision pipeline;
receive a selection of a prediction block and configuration information for the prediction block;
add the prediction block to the computer vision pipeline;
receive an output destination for the computer vision pipeline;
receive a request to activate the computer vision pipeline;
activate the computer vision pipeline;
receive input images and/or video from the input source;
transform, using the image transformation block, the input images and/or video to produce transformed images and/or video;
detect, using the prediction block, objects or classes of objects in the transformed images and/or video to produce detected objects or classes of objects; and
transmit the detected objects or classes of objects to the output destination.

9. The system of claim 8, the instructions being further executable by the at least one processor to display a user interface element into which a block may be dragged and dropped to select the block, and wherein the instructions being executable by the at least one processor to receive the selection of the image transformation block and configuration information for the image transformation block include instructions being executable by the at least one processor to receive a dragging and dropping of the image transformation block into the user interface element, and wherein the instructions being executable by the at least one processor to receive the selection of the prediction block and configuration information for the prediction block include instructions being executable by the at least one processor to receive a dragging and dropping of the prediction block into the user interface element.

10. The system of claim 8, the instructions being further executable by the at least one processor to:
receive a computer vision pipeline type, the computer vision pipeline type being one of a batch type or a streaming type;
if the computer vision pipeline type is the batch type, receive a processing schedule, wherein the instructions being executable by the at least one processor to receive input images and/or video from the input source includes instructions being executable by the at least one processor to receive input images and/or video from the input source according to the processing schedule; and
if the computer vision pipeline type is a streaming type, wherein the instructions being executable by the at least one processor to receive input images and/or video from the input source includes instructions being executable by the at least one processor to continually receive input images and/or video from the input source.

11. The system of claim 8 wherein the multiple image transformation blocks include an image crop block that crops images and/or video and an image resize block that resizes images and/or video.

12. The system of claim 8 wherein the multiple prediction blocks include a tiled model block that splits images and/or video into multiple images for detection of objects or classes of objects, detects objects or classes of objects in the multiple images, recombines the multiple images to produce transformed images and/or video, and produces the transformed images and/or videos and detections of objects or classes of objects.

13. The system of claim 8 wherein the multiple prediction blocks include a tiled model block that splits images and/or video into multiple images for detection of objects or classes of objects, detects objects or classes of objects in the multiple images, recombines the multiple images to produce transformed images and/or video, and produces the transformed images and/or videos and detections of objects or classes of objects.

14. The system of claim 8, the instructions being further executable by the at least one processor to display a summary of the computer vision pipeline, the summary including the input source, the image transformation block, the prediction block, an order of the image transformation block and the prediction block in the computer vision pipeline, and the output destination.

15. A method comprising:
receiving a request to create a computer vision pipeline for processing images and/or video;
receiving an input source for images and/or video for the computer vision pipeline;
displaying multiple blocks for selection, the multiple blocks including multiple image transformation blocks, an image transformation block transforming images and/or video to produce transformed images and/or video, and multiple prediction blocks, a prediction block detecting objects or classes of objects in images and/or video to produce detected objects or classes of objects;
receiving a selection of an image transformation block and configuration information for the image transformation block;
adding the image transformation block to the computer vision pipeline;
receiving a selection of a prediction block and configuration information for the prediction block;
adding the prediction block to the computer vision pipeline;
receiving an output destination for the computer vision pipeline;
receiving a request to activate the computer vision pipeline;
activating the computer vision pipeline;
receiving input images and/or video from the input source;
transforming, using the image transformation block, the input images and/or video to produce transformed images and/or video;
detecting, using the prediction block, objects or classes of objects in the transformed images and/or video to produce detected objects or classes of objects; and
transmitting the detected objects or classes of objects to the output destination.

16. The method of claim 15, further comprising displaying a user interface element into which a block may be dragged and dropped to select the block, and wherein receiving the selection of the image transformation block and configuration information for the image transformation block includes receiving a dragging and dropping of the image transformation block into the user interface element, and receiving the selection of the prediction block and configuration information for the prediction block includes receiving a dragging and dropping of the prediction block into the user interface element.

17. The method of claim 15, further comprising:
receiving a computer vision pipeline type, the computer vision pipeline type being one of a batch type or a streaming type;
if the computer vision pipeline type is the batch type, receiving a processing schedule, wherein receiving input images and/or video from the input source includes receiving input images and/or video from the input source according to the processing schedule; and
if the computer vision pipeline type is a streaming type, wherein receiving input images and/or video from the input source includes continually receiving input images and/or video from the input source.

18. The method of claim 15 wherein the multiple image transformation blocks include an image crop block that crops images and/or video and an image resize block that resizes images and/or video.

19. The method of claim 15 wherein the multiple prediction blocks include a tiled model block that splits images and/or video into multiple images for detection of objects or classes of objects, detects objects or classes of objects in the multiple images, recombines the multiple images to produce transformed images and/or video, and produces the transformed images and/or videos and detections of objects or classes of objects.

20. The method of claim 15 wherein the multiple prediction blocks include a label detection block that detects objects in images and/or video and produces one or more label descriptions for the detected objects, a landmark detection block that detects landmarks in images and/or video and produces a detected landmark description, and a logo detection block that detects logos in images and/or video and returns a detected logo description.
